(19) United States
(12) Patent Application Publication
(10) Pub. No.: US 2007/0192124 A1
(43) Pub. Date: Aug. 16, 2007

(54) Order fulfillment system

(76) Inventors: Jeff Anderson, San Diego, CA (US); Joseph Barrus, San Diego, CA (US); Patti Giberson, Vista, CA (US); Bharat Gogia, (US); Dan McCauley, San Diego, CA (US); Jerome Snell, San Diego, CA (US); Brent Vincent, San Diego, CA (US)

Correspondence Address: PETER K. TRZYNA, ESQ., P O BOX 7131, CHICAGO, IL, 60680, US

(21) Appl. No.: 11/590,568

(22) Filed: Oct. 30, 2006

Related U.S. Application Data
(60) Provisional application No. 60/731,961, filed on Oct. 31, 2005.

(51) Int. Cl. G06Q 99/00

(52) U.S. Cl. 705/1

(57) ABSTRACT

A computing system sending, across a wide area network, a real-time stream of orders, such as delivery date-specific. The computer system can be interposed between a web processing system and a provider of shipments and preferably utilizing a carrier management system. Exemplary embodiments include, depending on the implementation, apparatus or system, communication systems, articles of manufacture, method of use and method of making, and corresponding products produced thereby, as well as data structures, computer-readable media tangibly embodying program instructions, manufactures, and necessary intermediates of any of the foregoing.

### PRIORITY STATEMENT

This is a continuation in part of U.S. patent application Ser. No. 60/731,961, filed Oct. 31, 2005 and titled “Order Fulfillment System” and incorporates by reference: U.S. patent application Ser. Nos. 60/700,062, filed Jul. 18, 2005, and titled “Multi-Carrier Management System”; 60/731,792 filed Oct. 31, 2005, and titled “Grower System”; Ser. No. 11/488,546, titled “Multi-carrier Management System,” filed: Jul. 17, 2006, and that application being filed contemporaneously herewith title “Shipment Provider System” with Express Mail Label EQ139851580US—all filed by the same inventors. Also, incorporated by reference are: U.S. patent application Ser. No. 09/149,650, filed Aug. 9, 1998 and titled “Computer Control System Located at an Order Center for Shipping Product from a Remotely Located Distribution Center”; Ser. No. 09/847,644 filed May 2, 2001 and titled “Generating a Courier Shipping Label or the Like, Including an Ornamental Graphic Design, at a Non-courier Printer” and Ser. No. 09/776,956 filed Feb. 5, 2001, and titled “Generating a Courier Shipping Label or the Like, Including an Ornamental Graphic Design, at a Non-courier Printer”.

### COMPUTER CODE APPENDIX

A portion of the disclosure of this patent document contains material that is subject to copyright protection. The copyright owner has no objection to a statutory fair use of this material, as it appears in the files of the files or records of the U.S. Patent and Trademark Office, but otherwise reserves all copyright rights whatsoever. Computer code (as an appendix incorporated herein) is provided on the enclosed two (2) CD-ROM discs. Each of the discs contains the same information as the other.

This patent application includes Appendix with code on a CD, the CD filed herewith being incorporated by reference herein. The machine format is Industry Standard, the operating system compatibility is MS Windows. Most of the files are viewable in a simple text format, but are best interpreted, and only editable, using MS Visual Studio or the other MS software product designated for such file, and a list of the files contained on the CD-Roms, including their names, sizes in bytes, and dates of creation is as follows:

LENGTHY TABLE REFERENCED HERE
US20070192124A1-20070816-T00001
Please refer to the end of the specification for access instructions.

### TECHNICAL FIELD

The technical field is computers and data processing systems, as illustrated more particularly herein. Exemplary embodiments include, depending on the implementation, apparatus, communication systems, articles of manufacture, method of use and method of making the foregoing, and corresponding products produced thereby, as well as data structures, computer-readable media tangibly embodying program instructions, manufactures, and necessary intermediates of any of the foregoing.

### BRIEF DESCRIPTION OF THE DRAWINGS

FIG. 1 illustrates an embodiment.

FIG. 2 illustrates an embodiment.

FIG. 3 illustrates an embodiment.

FIG. 4 illustrates an embodiment.

FIG. 5 illustrates an embodiment.

FIG. 6 illustrates an embodiment.

FIG. 7 illustrates an embodiment.

FIG. 8 illustrates an embodiment.

FIG. 9 illustrates an embodiment.

FIG. 10 illustrates an embodiment.

FIG. 11 illustrates an embodiment.

FIG. 12 illustrates an embodiment.

FIG. 13 illustrates an embodiment.

FIG. 14 illustrates an embodiment.

FIG. 15 illustrates an embodiment.

FIG. 16 illustrates an embodiment.

FIG. 17 illustrates an embodiment.

FIG. 18 illustrates an embodiment.

FIG. 19 illustrates an embodiment.

FIG. 20 illustrates an embodiment.

FIG. 21 illustrates an embodiment.

FIG. 22 illustrates an embodiment.

FIG. 23 illustrates an embodiment.

FIG. 24 illustrates an embodiment.

FIG. 25 illustrates an embodiment.

FIG. 26 illustrates an embodiment.

FIG. 27 illustrates an embodiment.

FIG. 28 illustrates an embodiment.

### MODES

The accompanying drawings are intended to illustrate and exemplify in a teaching manner. Therefore, embodiments used to carry out the teaching should not be viewed as limiting, but rather, should be viewed as instructively building to an overall teaching.

As used herein, the term “computer” or “computer system” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow can be implemented in discrete circuits. Computer-readable media, as used herein can comprise at least one of a RAM, a ROM, a disk, an ASIC, and a PROM. Industrial applicability is clear from the description, and is also stated below.

By way of the following prophetic teaching, there is provided computer (and support thereof), as in a data processing system, for implementations pertaining to embodiments herein, as well as related or necessary computer support such as for providing or facilitating shipments responsive to orders.

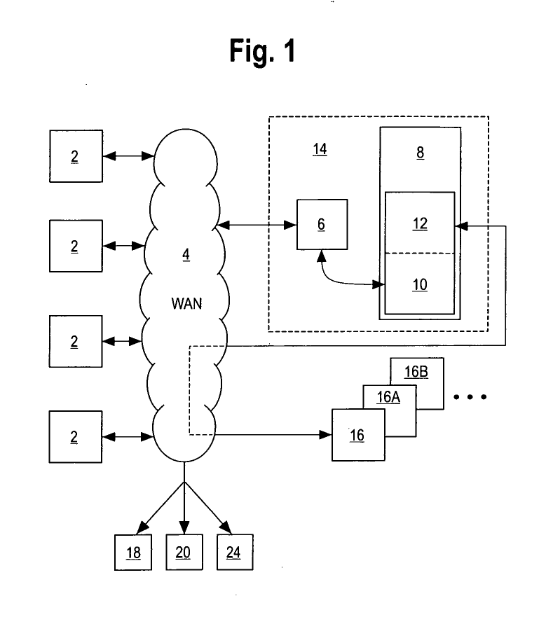

FIG. 1 illustrates an embodiment, though it is to be understood that this is for teaching, rather than limiting, particularly as regards an overview. Many variations and embodiments can utilize this teaching to variations suitable for one application or another, depending on the particulars of the situation of use.

By way of a prophetic example, there can be a plurality of customer or end user computer systems 2, each connected to a wide area network 4, such as the Internet. Computer systems 2 communicate over WAN 4 to an order receiving computer system 6, such as a web page on a server so perhaps to also comprise an e-commerce ordering center computing. System 6 is adapted to capture a customer or end-user order. The communicating can produce an order placed by one of the computer systems 2, and if desired, the order can be accompanied with a personalized greeting card message to the recipient of the order, and also if desired, ornamentation to the carrier waybill.

Order receiving computer system 6, depending on the configuration, can communicate with computing system(s) 8, which comprises logic to orchestrate order processing prior to conveying the order to a shipment provider computer system, e.g., a system that responds to the order by producing a package for shipment by a carrier such as Federal Express or UPS.

Preferably computing system(s) 8 is/are distinct from the order receiving computer system 6. Preferably, computing system 8 can be comprised of at least two distinct computing systems; system 10 can select a shipment provider from a plurality of a shipment providers, and preferably system 10 can also form a provider/carrier pair. For example, system 10 can, but need not, comprise a multi-carrier system such as that illustrated in Ser. No. 11/488,546. In one preferred embodiment, system 10 can interact with a fulfillment computer system 12, which preferably is distinct from system 10. These functions could, in some embodiments, be consolidated (in whole or part) into an integral system 14, depending on the particular embodiment preferred.

Preferably, though, fulfillment system 12 can handle orchestrating order fulfillment processing prior to conveying or communicating the orders to a shipment provider computer system 16, e.g., getting the right information to the right shipment provider (preferably there are a plurality of a shipment provider computer systems 16A, 16B, etc.), preferably with the right carrier and preferably with the right routing logic, to handle the shipment optimally, e.g., for delivery date-specific orders of perishables. System 12 also can perform workflow management, such as holding orders from provider systems 16 until an optimal time, e.g., 5 days prior to release. System 12 can also handle tracking, order modification and cancellation, etc. In a sense, system 12 can interact with logic such as a multi-carrier system 10 in “creating” a shipment order such that the order is sent to a supplier, such as a shipment provider, e.g., a grower of a perishable that is used in the shipment. The orchestration is also, in a sense, order transporting, prior to being sent to a system 16 via WAN 4.

Other computer systems, such as that for each carrier 18, etc. (e.g., Federal Express, UPS), that for each financial institution 20, etc. (e.g., Mastercard, American Express), and regional and other product distribution centers 24. See, e.g., Ser. No. 09/149,650.

A note on what is contemplated by “distinct system” as used herein. Distinct systems are not integrally coded, but can communicate and distinct programs can run on the same computer as contrasted with a preferred embodiment of having programs running on dedicated processors. Distinct programs can pass data, e.g., at an application level via a TCP socket, via writing to a database that is later read by another program, via a message bus, etc.

Computing systems 6-16 can be an Intel-based system(s), with a Windows-based operating system, though a Unix system is another an alternative. System 14, or in a more particular embodiment, system 12, can have a display or monitor for displaying user interfaces discussed subsequently herein.

The shipments made to fulfill orders can each include a good, but preferably there is at least one perishable, and/or such as an accessory. For example, a shipment of a bouquet of flowers can include a vase as an accessory; a shipment of fruit can include a basket as an accessory. Stuffed animals, balloons, are other examples of accessories. It is also possible for the shipments to include different kinds of perishables, such as fruit and chocolate, flowers and chocolate, etc; and it is also possible for the shipper to be a producer of that which is shipped. It is further possible to ship one kind of perishable, such as chocolate, to satisfy one or more orders; and a different kind of perishable, such as flowers, to satisfy one or more other orders, and any combination thereof.

The shipments can be boxes that include the goods corresponding to the respective orders, along with a card with a message sent by one exemplary purchaser's computing system 2 to the recipient of one of the shipments. See, e.g., U.S. patent application Ser. No. 09/149,650 filed Aug. 9, 1998 and titled “Computer Control System Located at an Order Center for Shipping Product from a Remotely Located Distribution Center.”

As previously mentioned, there can be one or more purchaser's computer systems 2. At least one of the purchaser's computer systems 2 can include a digital computer with a processor (such as an Intel Pentium or Centrino processor), a memory, an input device (such as a keyboard, mouse, speech recognizer, disk or CD drive, computer-to-computer communication device, etc.), and an output device (such as a monitor, printer, disk or CD drive, or a computer-to-computer communication device such as a modem). The memory can include an operating system such as Windows or Linux to run the purchaser's computer systems 2, for example, enable application(s) software. The purchaser's computer systems 2 can use its computer-to-computer communication device to communicate via wide area network 4, such as the Internet.

Depending on the embodiment of choice, computer system 14, preferably 8, and more preferably 12 is adapted for sending, over a WAN 4, a real-time stream of orders, preferably delivery date-specific orders. The computing system 16 is programmed for processing the stream, including controlling printing of the stream of the orders.

One way of thinking of computer system 12 is that it sends that which is received by system 16 (see the “Shipment Provider System” patent application incorporated by reference and filed contemporaneously herewith), and that which is sent by system 16 is received by system 12.

So, as illustrated in FIG. 1, the real-time stream of orders, preferably delivery date-specific orders, can include a real-time stream of delivery date-specific orders sent by an e-commerce order processing system 14, preferably comprised of computer systems 10 and 12, for example. Preferably fulfillment system 12 can be sending the real-time stream of delivery date-specific orders to system 16, wherein the real-time stream of delivery date-specific orders includes at least one order communicated by the purchaser's computer system 2.

Accordingly, an embodiment can be formulated such that the computer system 12 can be interposed between a web processing system 6 and one of a plurality of providers 16 of shipments, and preferably utilizing a carrier management system 10. That is, fulfillment system 12 can be interposed between a carrier or multi-carrier system 10 and one of a plurality of providers 16 of shipments.

The computer system 16 can be programmed to send a stream of real time status information to, for example, computer system 12, the information corresponding to at least some of the orders. Another embodiment is a computer-readable media tangibly embodying a program of instructions executable by a computer in a system to perform the operations discussed herein. The media can include at least one of a RAM, a ROM, a disk, an ASIC, and a PROM. With regard to the programming, see the appendix code, Figures, and text herein, that can also serve to exemplified “means for” embodiments.

Despite the general applicability of the order fulfillment embodiments that are a particular focus herein, there is particular applicability in connection with perishables and other time-sensitive products for order fulfillment, and even more so where the fulfillment is for large quantities of small orders and there can be a plurality of those doing the shipment preparation for fulfillment. Flowers ordered over the Internet are a particularly suitable example. Thus, the teaching herein uses a grower system as an example of order fulfillment in general.

In an example of order fulfillment, an embodiment can enable a grower (e.g., of flowers), on location, to remotely retrieve and process orders such as that corresponding to, and in cooperation with, any of the patent applications incorporated by reference herein. Information about the status of these orders can be maintained and used by both the grower and the administration communicating orders to the grower.

The administration, e.g., at 14, handles a new order or a modified order from a user/customer via system 2. The administration causes order details to be inserted into a grower database, preferably inserted in the appropriate one of a plurality of grower databases, e.g., at the administration server.

Architecture is a set of views which illustrate one of many possible ways to carry out an embodiment. Two types of views can be considered: a static view and a dynamic view. Static view illustrates the structure and a dynamic view illustrates the interactions of components; together they represent one, but not the only possible, implementation.

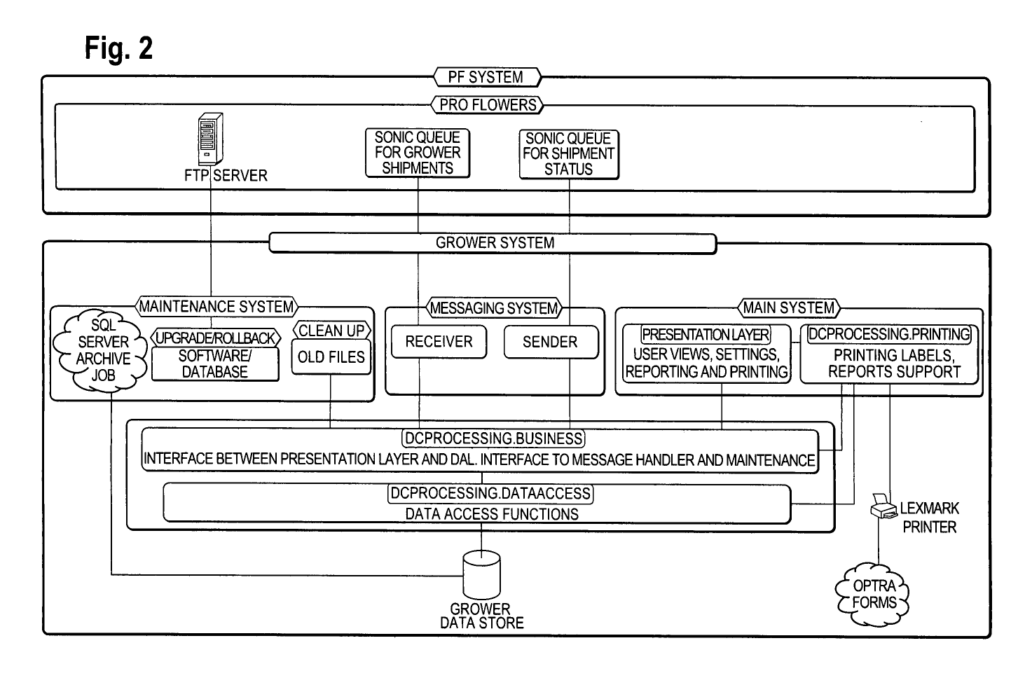

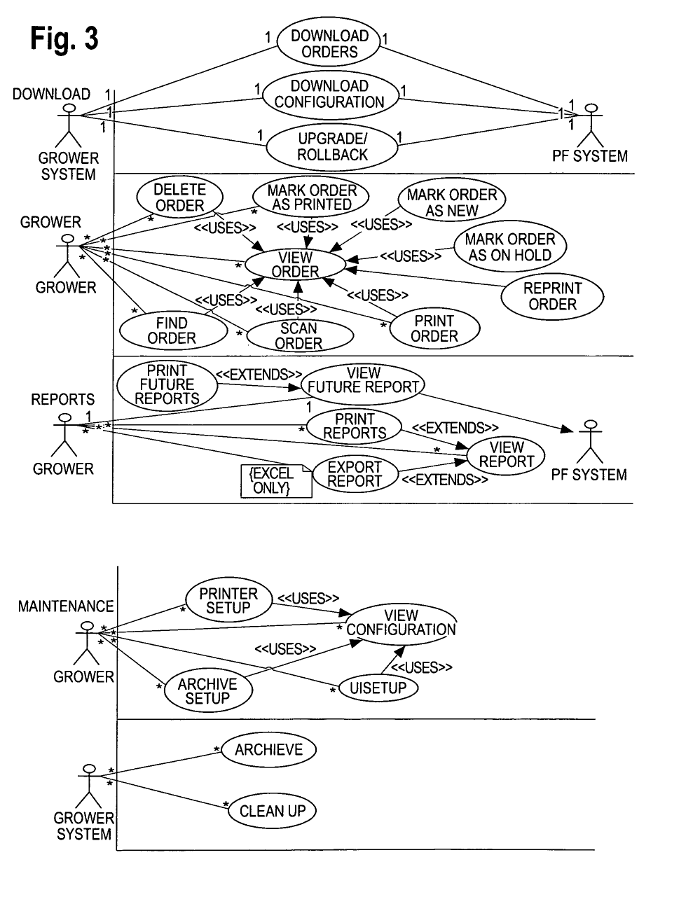

In case of an Internet trading system for obtaining customer orders, FIG. 2 shows is illustrative of systems 14 and 12 interacting with system 16. There can be a 2 or 3-tier architectural layer of presentation encompassing, for example, web services/windows forms, business, and data access. FIG. 3 shows a dynamic view corresponding to maintenance system 13, messaging system 15, and main system 17. See the “Shipment Provider System” patent application incorporated by reference for further details.

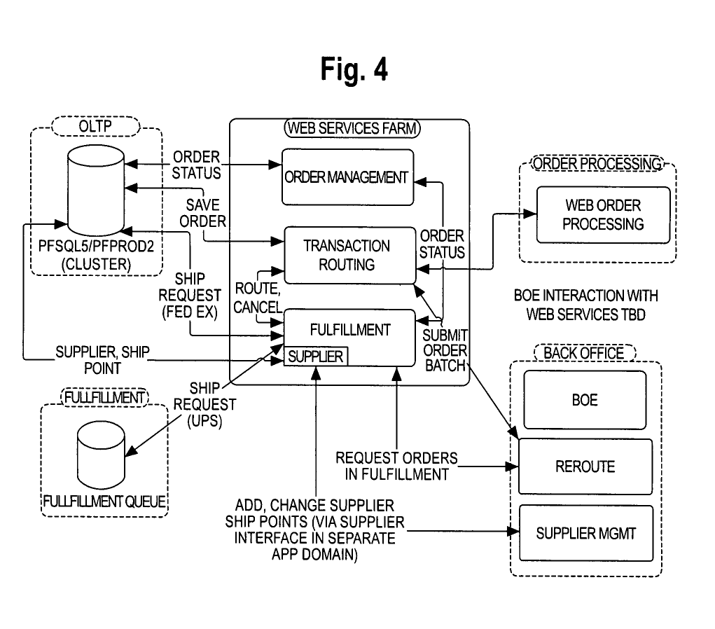

Turn now to FIG. 4, which provides an exemplary view of system 14.

The Supplier Management Application 26 can provide for one or more operations involving supply, and can also be made able to add or update ship point(s). A New Ship Point can be added in to a database 28 with the required data. The Supplier Management application 26 can, but need not, be encompassed component layers. Preferably there is an n-tier system in FIG. 3 with, for example, Web-based front end 6, Web services 14 (fulfillment 12, Transaction Routing 11, and product management 30), Business Layer 32, Data Access Layer and Databases (fulfillment 34 and On Line Transaction Database (“OLTP”) 28). Transaction Routing 11 routs orders to fulfillment services for processing (e.g., payment processing, routing service 10 for selecting the supplier/carrier combination, the order management service for saving the order, etc.) Transfer Routing 11 interacts with such as a multi-carrier system or other means for selecting a supplier/carrier combination for the order and means for submitting the order to a shipping service to create the shipment with the specific carrier system. Reroute 15 handles request orders in Fulfillment 12. The OLTP 28 can be a primary database for capturing and managing e-commerce orders. All the data access calls can be routed from web application through the web service 6, the Business layer 32, and the Data Access Layer, which can be understood as a set of code used to abstract the interaction within the system or underlying database(s).

In FIG. 4, a Bulk Order Application (“BOE”) 13 interacts with Transaction Routing 11.

A User interface layer can comprise .NET web pages (file extension: aspx) and .NET User Controls (file extension: ascx) for such as five User Interface screens along with the code behind files. (See code in the appendix.) The User interface layer calls Web service functionality. Web Page calls Web service Methods for Data Access.

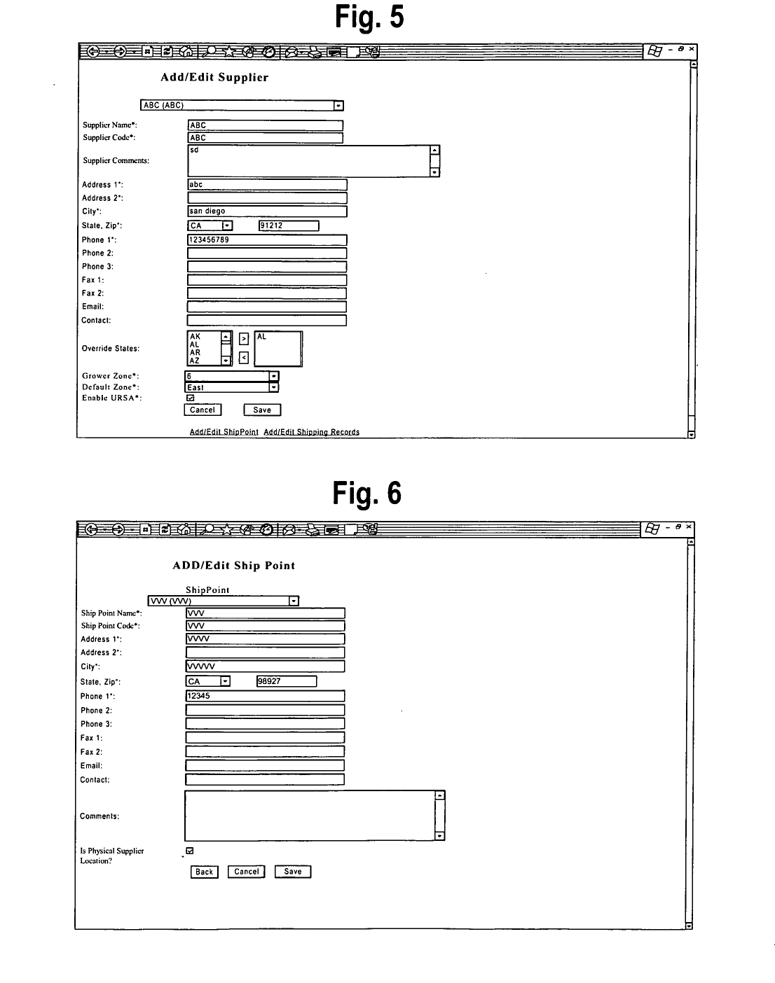

From Page 1 (FIG. 5) of the user interface, there can be:
New Supplier:
Stores new Supplier details into the database.
Edit Supplier:
Display Supplier details that need to be updated.
Update the details and save it into the database.
Cancel Supplier:
In Add mode clicking on cancel just clears the form.
In Edit Mode clicking on cancel restores form back to the values from db.

Any of the following fields can be on the screen of FIG. 5.
Supplier
Supplier Name
Supplier Code
Supplier Comments
Address 1
Address 2
City
State
Zip
Phone 1
Phone 2
Phone 3
Fax 1
Fax 2
Email
Contact
Override States
Grower Zone
Default Zone
Enable URSA
Supplier Ship Points (link)
Add/Edit Shipping Records (link)

In the above Supplier Name, Supplier Code, Address 1, City, State, Zip, Phone 1, Fax 1, Override States, Grower Zone, Default Zone and Enable URSA are required fields.
New Supplier:
Select “New Supplier” from the supplier combo.
All fields in the screen should be blank or reset.
Edit Supplier:
Select a supplier from the supplier combo.
Available Supplier details of particular supplier should be placed in the corresponding fields in the screen.
Allow to save the newly added or updated supplier in the database.
Cancel Supplier:
Allow to cancel all changes done by user from last save on supplier and refreshes data

FIG. 6, New Ship Point:
Stores new Ship Point details in to the database.
Edit Ship Point:
Display Ship Point details that need to be updated.
Update the details and save it into the database.
Cancel Ship Point:
In Add mode clicking on cancel just clears the form.
In Edit Mode clicking on cancel restores form back to the values from db.
Back:
Takes user back to Add/Edit Supplier page

The screen of FIG. 6 can include any of the following fields:
Ship Point
Ship Point Name
Ship Point Code
Address 1
Address 2
City
State
Zip
Phone 1
Phone 2
Phone 3
Fax 1
Fax 2
Email
Contact
Ship Point Comments
IsPhysicalSupplierLocation

In the above Ship Point Name, Ship Point Code, Address 1, City, State, Zip, Phone 1 are required fields.
New Ship Point:
Select “New Ship Point” from the Ship Point combo.
All fields in the screen should be blank or reset.
Edit Ship Point:
Select a Ship Point from the Ship Point combo.
Available Ship Point details of particular Ship Point should be placed in the corresponding fields in the screen.
Allow to save the newly added or updated Ship Point in the database.
Cancel Ship Point:
Allow to cancel all changes done by user from last save on Shippoint and refreshes data
Back to Supplier:
Allow user go back to Add/Edit Supplier

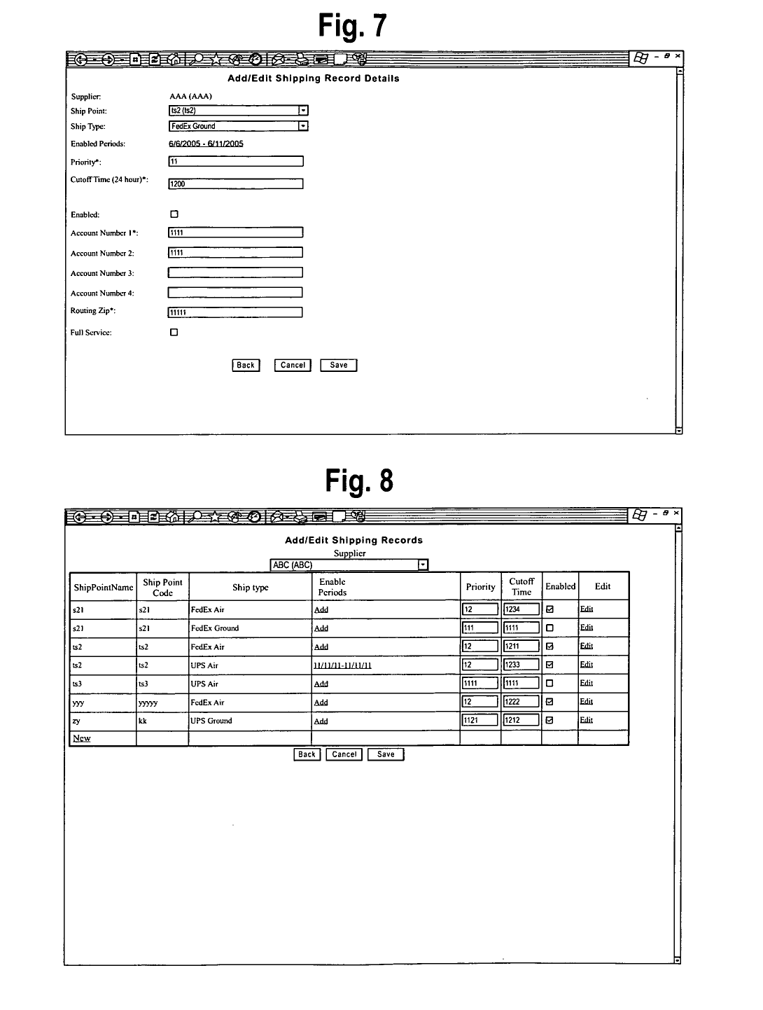

FIG. 7 illustrates add/edit shipping records:
Edit Shipping Records
List all Suppliers.
Display supplier ship point details on Supplier Ship point grid for selected Supplier.
Allows editing Supplier Ship Point details (Priority, CutOffTime, Enabled)
Allows adding new ship point to a particular supplier.
Allows editing the existing ship point of a particular supplier.
Allows to add/edit the existing shipping period of a particular supplier's ship point
Cancel Shipping Records:
In Add mode clicking on cancel just clears the form.
In Edit Mode clicking on cancel restores form back to the values from db.
Back:
Takes user back to Add/Edit Supplier

The screen of FIG. 7 can include any of:
Display Supplier Ship Point grid and can have the following column headers:
Ship Point Name
Ship Point Code
Ship Type
Enabled Periods
Priority
Cutoff Time
Enabled
Edit
Priority, Cutoff Time and Enabled columns are editable.
Edit Shipping Records:
Select a supplier from the combo.
Display Supplier Ship Point details of selected Supplier in grid.
Display most recent EnabledPeriodDates links for SupplierShippingRecords
Allow to save updated SupplierShipPoint details in the database
Allow to add/edit Enabled Period, on Add/EditEnabledDates by clicking on Add/EnablePeriod link
Allow to add new SupplierShipPoint by clicking on New link
Cancel Shipping Records:
Allow to cancel all changes done by user from last save on SupplierShipPointRecords and refreshes data
Back to Supplier:
Allow user go back to Add/EditSupplier

FIG. 8 illustrates Supplier's Ship Points
New Supplier's Ship Point:

Allows creating new relationship between supplier and ship point. And creates a new shipping location.
Edit Supplier's Ship Point:
Display Supplier Ship Point details that need to be updated.

Update the details and save it into the database.
Able to add new shipping period of a particular supplier ship point.
Cancel Supplier ShipPoint: 10 In Add mode clicking on cancel just clears the form.
In Edit Mode clicking on cancel restores form back to the values from db.
Back:
Takes user back to Add/Edit Shipping Records

The screen in FIG. 8 can include any of the following fields: screen.
Supplier
Ship Point
Ship Type
Enabled Period
Priority
Cutoff Time (24 hour)
Enabled
Account Number 1
Account Number 2
Account Number 3
Account Number 4
Routing Zip
Full Service.
Priority, Cutoff Time and Account Number1,RoutingZip are required fields.
Display Supplier Ship Point details of selected Supplier on corresponding fields.
Allow to save the newly added or updated Supplier's Ship Point in the database.
Display most recent EnabledPeriodDates links for SupplierShipPoint
Allow to edit Enabled Period, on Add/EditEnabledDates by clicking on EnablePeriod link
Allow to add new Enable Period on Add/EditEnabledDates by clicking on Add link
Cancel SupplierShipPoint:
Allow to cancel all changes done by user from last save on SupplierShipPoint and refreshes data
Back to SupplierShippingRecords:
Allow user go back to Add/EditShippingRecords

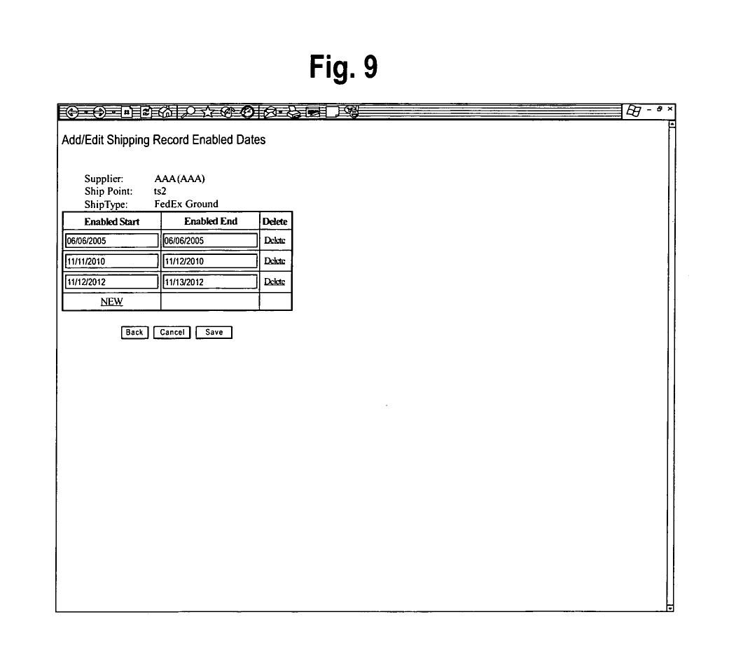

FIG. 9 illustrates edit supplier ship points:
New Enabled Dates:
Stores new Enable Period for a particular supplier's ship point.
Edit Enabled Dates:
Display Enable period that need to be updated.

Update Enable period and save it into the database.
Cancel Enabled Dates:
In Add mode clicking on cancel just clears the form.
In Edit Mode clicking on cancel restores form back to the values from db.
Delete Enabled Period Dates:

Delete selected Enable Period for Supplier's Ship Point
Back:
Takes user back to Add/Edit Shipping Records or Add/Edit Supplier Ship Point, based on from where user accessed Add/Edit Enabled Dates

The screen in FIG. 9 can have any of the following display information:
Supplier
Ship Point
Ship Type
nEnabled Period grid
The Enabled Period grid can have following columns
Enabled Start
Enabled End
Delete
Display all EnabledPeriod for selected SupplierShipPoint in grid.
Allow to create a new row for EnabledPeriod
Allow to save the newly added or updated Supplier's Ship Point Enabled Dates in the database.
Allow delete Enabled Period
Does not allow adding overlapping periods.
Cancel the user entry:
Allow to cancel all changes done by user from last save on EnablePeriods and refreshes data
Back to previous page:
Allow user go back to page from where this page is called.

There can also be an exception handling page (not shown in a figure herein)
Error Message Display:
Shows description of error occurred
Allow user to continue further on Suppliermanagement

Such a screen can, for example:
Display a message to inform user that an unhandled error has occurred
Allows user to continue after displaying an error message.

For all screens necessary validation is performed on required fields.

Consider now the web service 6, which will then call business layer 32 and data access layer to get or save data. See too the code in the appendix.
Namespace: Application.WebServices. Fulfillment—For Supplier
Method: GetAllStates
Parameters: (depends on implementation as may be preferred)
Returns a States Dataset.
Description: Call GetStatesData in Supplier business layer to get all available states in DB.
Method: GetAllSupplierList
Parameters: (depends on implementation as may be preferred)
Returns a SupplierManagementDataSet Dataset.
Description: Calls GetSupplierList in Supplier Business layer to get all available Suppliers from DB.
Method: GetAllZones
Parameters: (depends on implementation as may be preferred)
Returns a ZoneDataSet Dataset.
Description: Calls GetAllZones in Supplier Business layer to get all grower zones and default zones from DB.
Method: GetSupplierDetail
Parameters: SupplierCode
Returns a SupplierManagementDataSet Dataset.
Description: Calls GetSupplierDetail in Supplier Business layer to get All Supplier Details from DB.
Method: SaveSupplierData
Parameters: SupplierManagementDataSet
Returns a ResultDataset Dataset.
Description: Calls SaveSupplierData in Supplier Business layer to Adds New Supplier in DB.
Method: UpdateSupplierData
Parameters: SupplierManagementDataSet
Returns a ResultDataset Dataset.
Description: Calls SaveSupplierData in Supplier Business layer to Update Existing Supplier in DB.
Method: GetAllShipPoints
Parameters: (depends on implementation as may be preferred)
Returns a SupplierManagementDataSet Dataset.
Description: Call GetAllShipPoints in ShipPoint business layer to get all available ShipPoints in DB.
Method: GetShipPointDetail
Parameters: ShipPointCode
Returns a SupplierManagementDataSet Dataset.
Description: Call GetAllShipPoints in ShipPoint business layer to Get All ShipPoint Details from database for a particular ship point.
Method: SaveShipPointData
Parameters: SupplierManagementDataSet
Returns a ResultDataset Dataset.
Description: Calls SaveShipPointData in ShipPoint Business layer to Add New ShipPoint in DB.
Method: UpdateShipPointData
Parameters: SupplierManagementDataSet
Returns a ResultDataset Dataset.
Description: Calls UpdateShipPointData in ShipPoint Business layer to Update Existing ShipPoint in DB.
Method: GetSupplierShipPointDetail
Parameters: SupplierCode
Returns a SupplierManagementDataSet Dataset.
Description: Call GetSupplierShipPointDetail in SupplierShipPoint business layer to get All ShipPoint Details from DB.
Method: GetAllShipTypes
Parameters: (depends on implementation as may be preferred)
Returns a ShipTypeDataSet Dataset.
Description: Call GetAllShipTypes in Supplier business layer to get All ShipTypes from DB.
Method: SaveSupplierShipPointData
Parameters: SupplierManagementDataSet
Returns nothing.
Description: Calls SaveSupplierShipPointData in SupplierShipPoint Business layer to Add New ShipPoint(s) for a particular supplier in DB.

The business layer 32 can comprise classes that contain business logic. This layer 32 interacts with the database(s) using the Database Access Layer.

With more particularity to the fulfillment system 12, in consideration of the code in the appendix:
Namespace: BusinessProcess.Fulfillment.Business
Class Name: SupplierBL (For Supplier)
Namespace: BusinessProcess.Fulfillment.Business
Class Name: ShipPoint (For ShipPoint)
Namespace: BusinessProcess.Fulfillment.Business
Class Name: SupplierShipPoint (For SupplierShipPoint)

The data access layer interacts with the database(s) by invoking the desired stored procedure and returning the result datasets.
Namespace: BusinessProcess.Fulfillment.DataAccess
ClassName: SupplierDAL (For SupplierDAL)
Namespace: BusinessProcess.Fulfillment.DataAccess
ClassName: SupplierDALCache (For SupplierDALCache)
Namespace: Business Process.Fulfillment.DataAccess
ClassName: SupplierDAL (For ShipPointDAL)
Namespace: BusinessProcess.Fulfillment.DataAccess
ClassName: SupplierShipPointDAL (For SupplierShipPointDAL)
Data Sets: data is transferred across different layers in the form of Datasets.
Namespace: BusinessProcess.Fulfillment.DataSets
Data Set names:
1. StatesDataSet
2. SupplierManagementDataSet
3. ShipTypesDataSet
4. ZoneDataSet
5. ResultDataset

An illustrative design can use:
CommonTechnology.configuration
CommonTechnology.Utility
MS Data Application blocks 2.0
MS Exception manager block
CommonTechnology.SessionManagement

Consider now exemplary use cases with reference to the code in the appendix, especially: AddEditSupplier.aspx, AddEditShipPoint.aspx, SupplierShipPoints.aspx, AddEditSupplierShipPoint.aspx, EditEnabledDates.aspx. See also, if desired, UnHandledException.aspx.

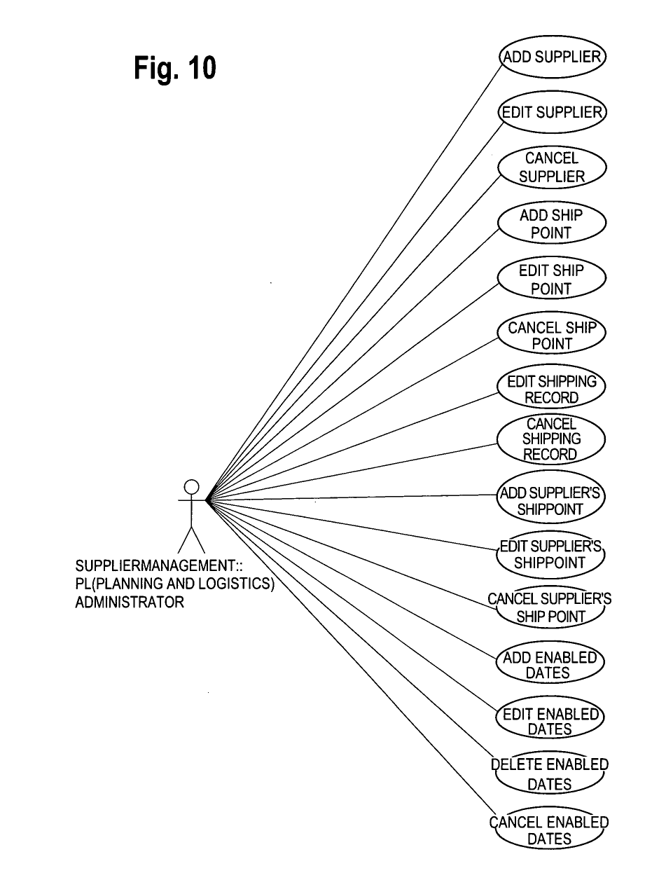

Commence with FIG. 10, which illustrates an overview of potential use cases concerning Supplier Management application 26.

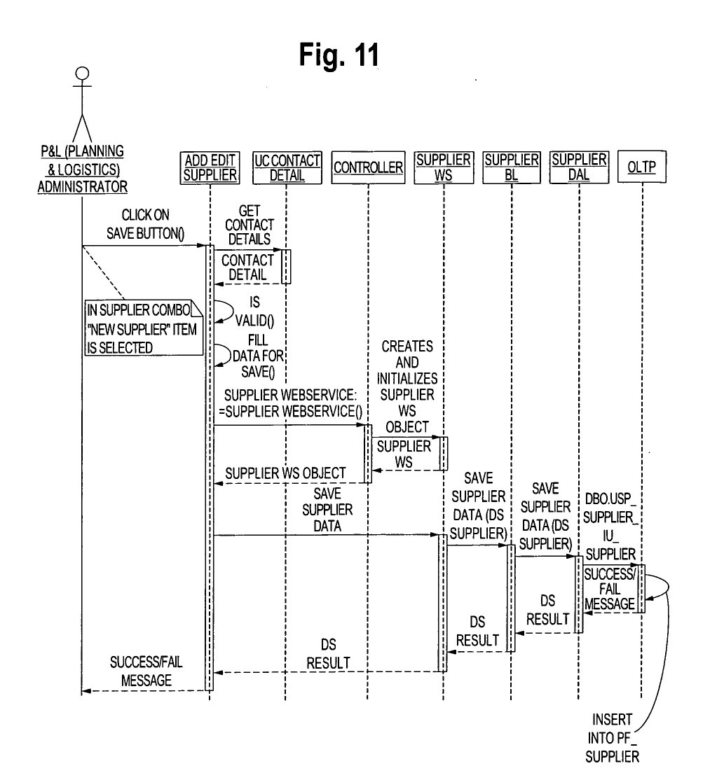

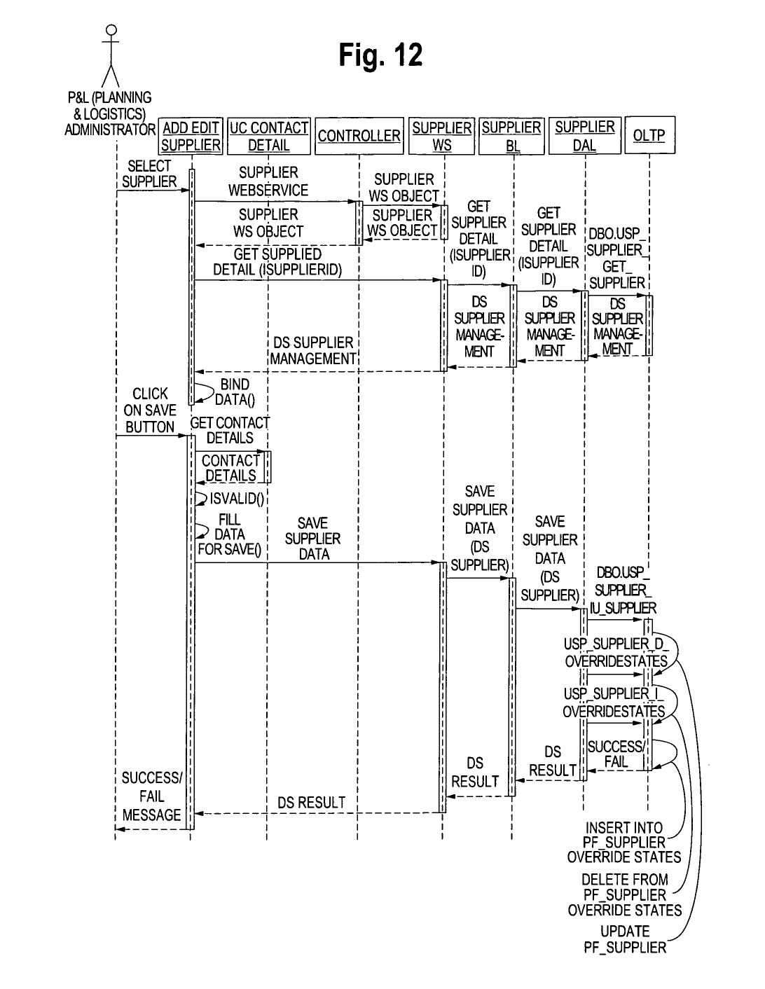

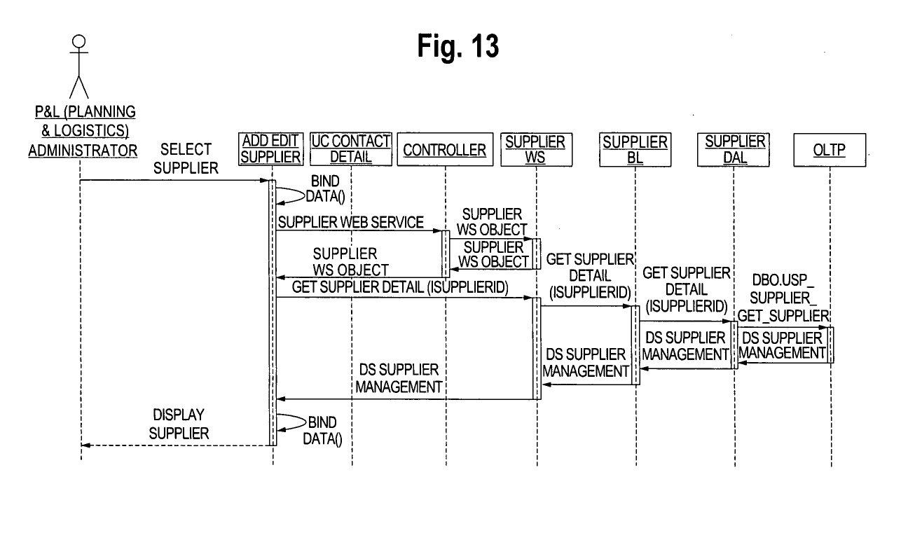

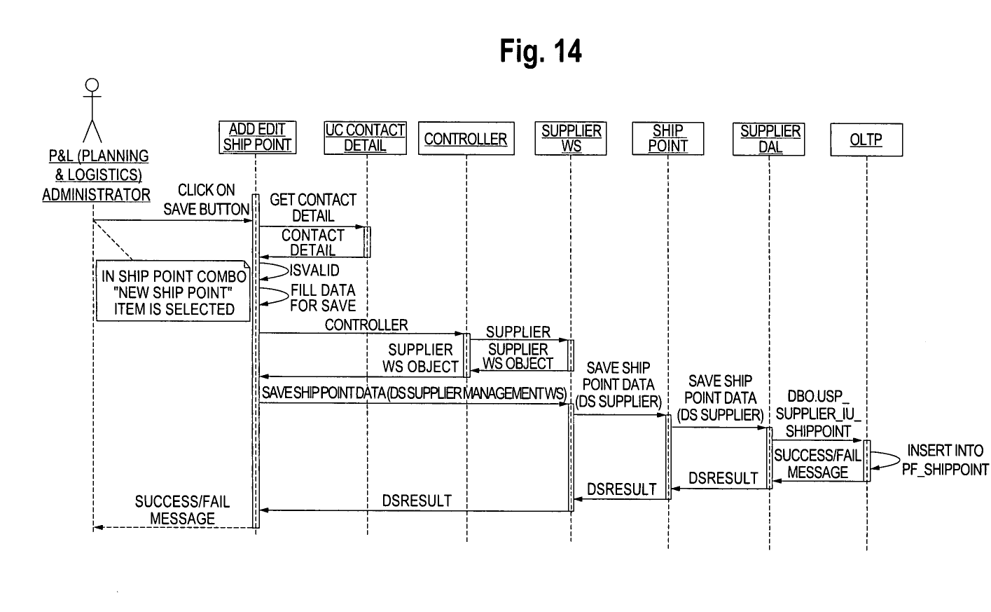

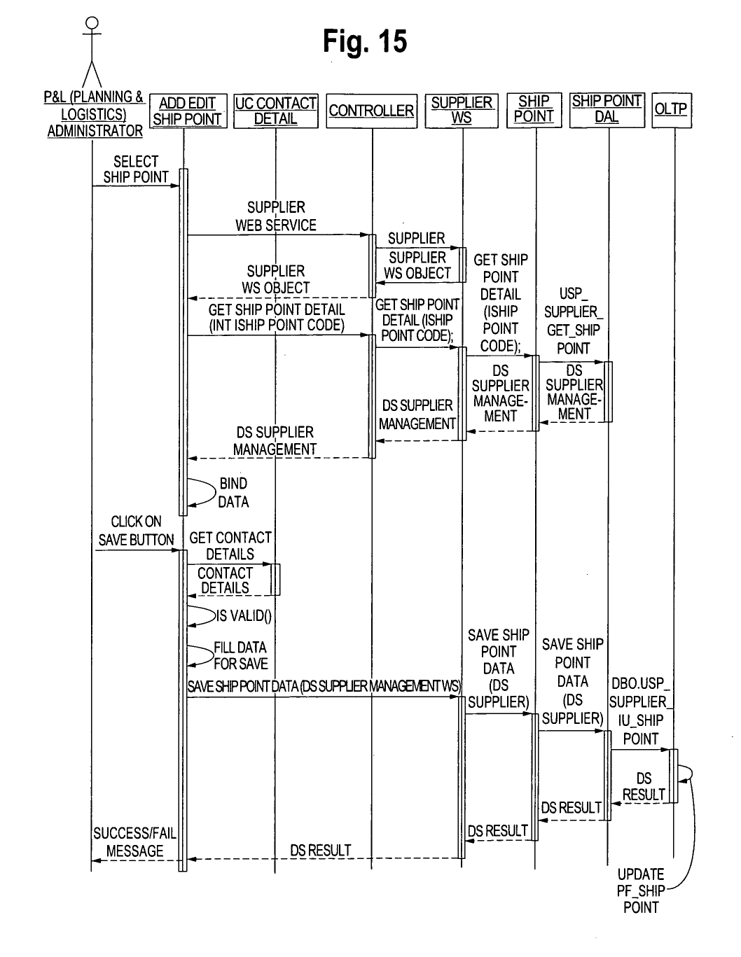

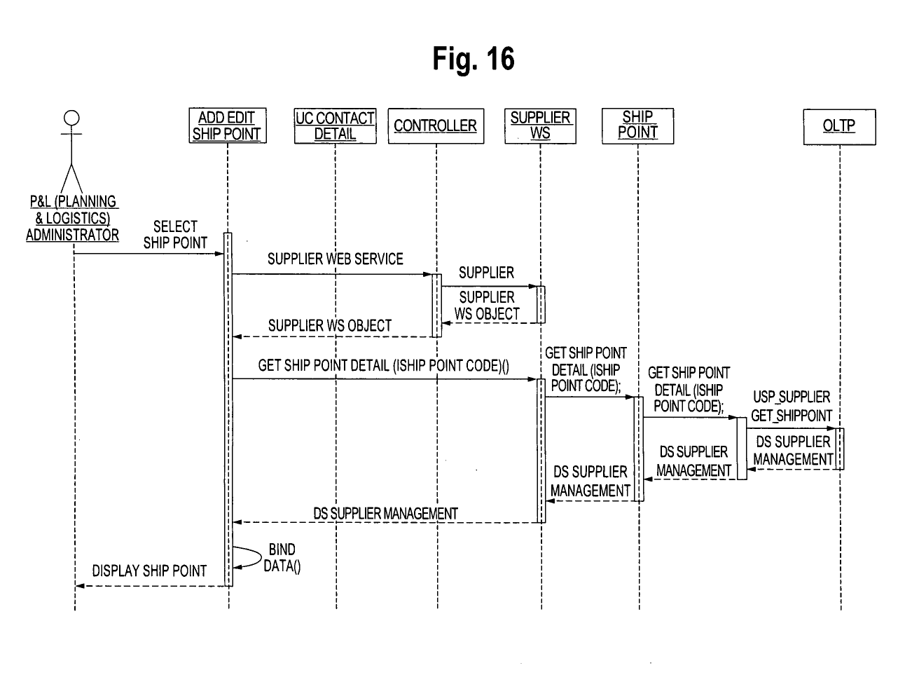

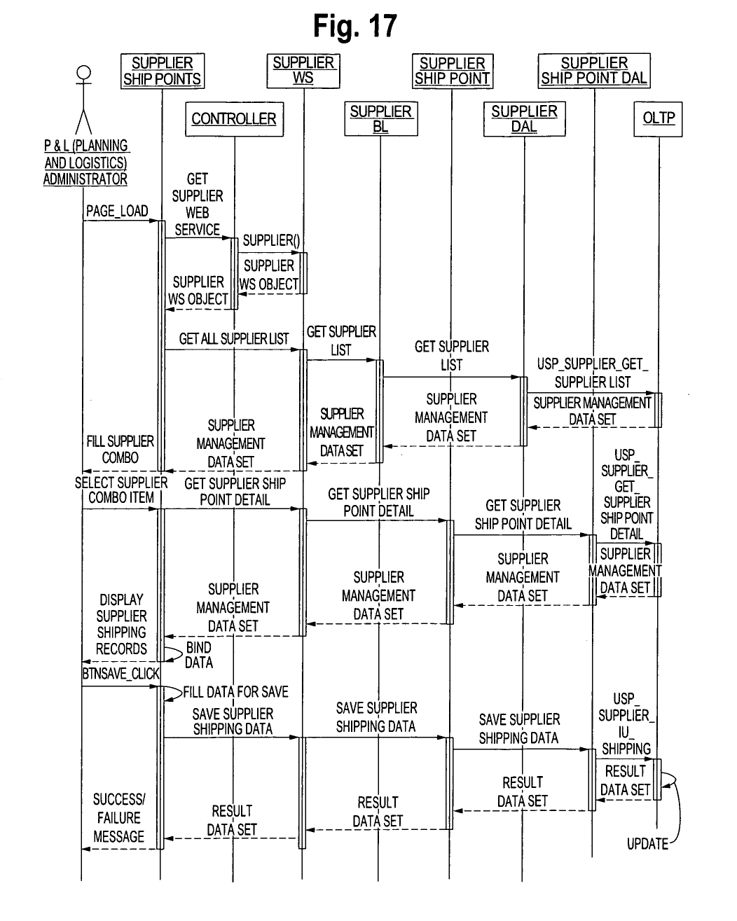

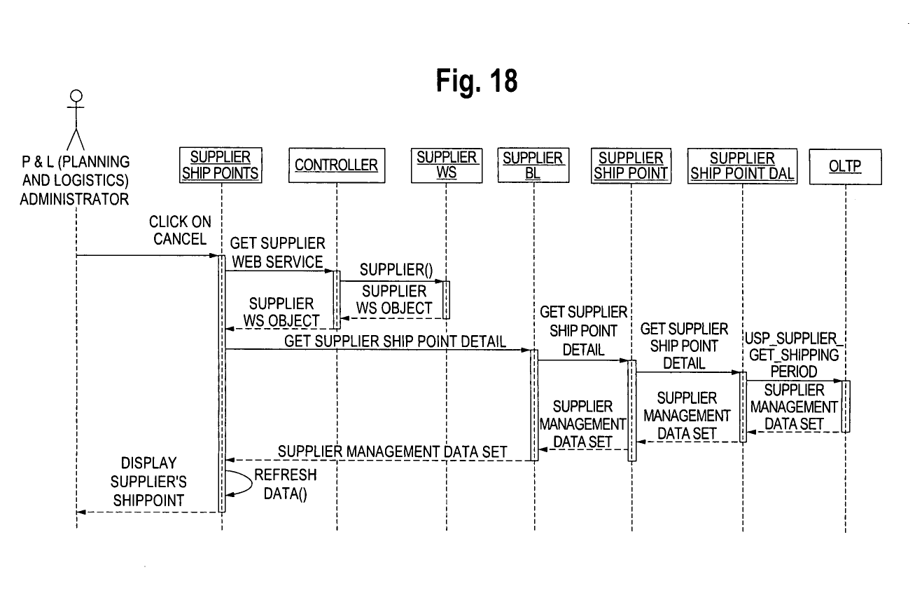

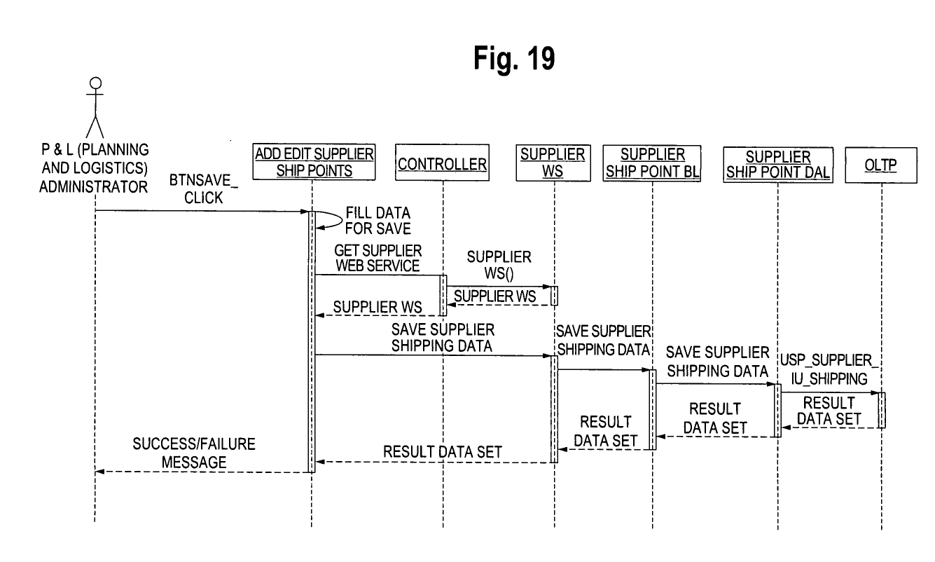

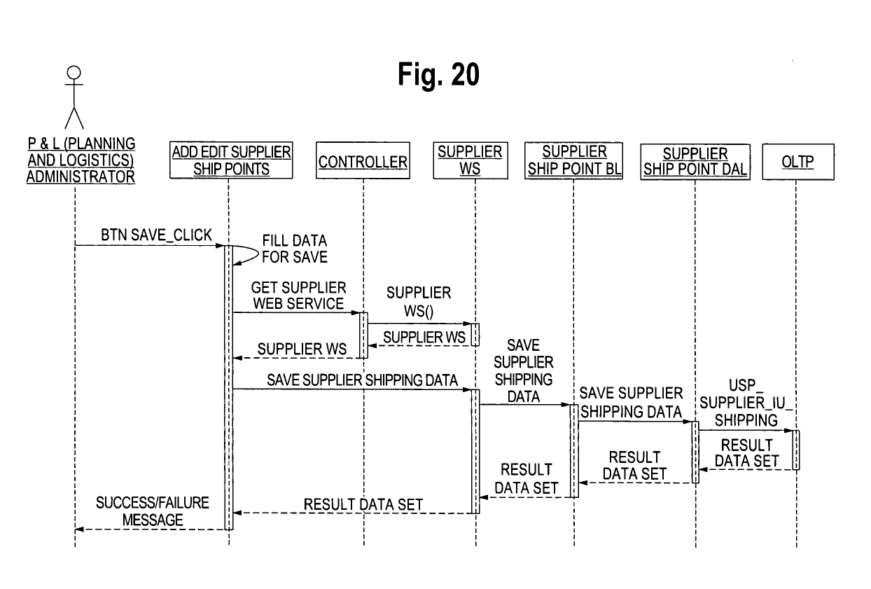

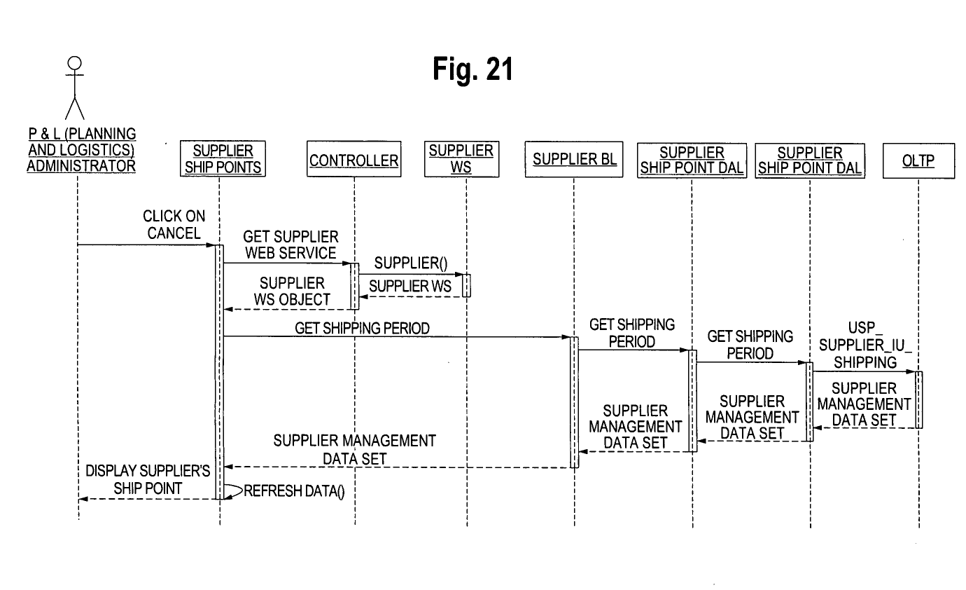

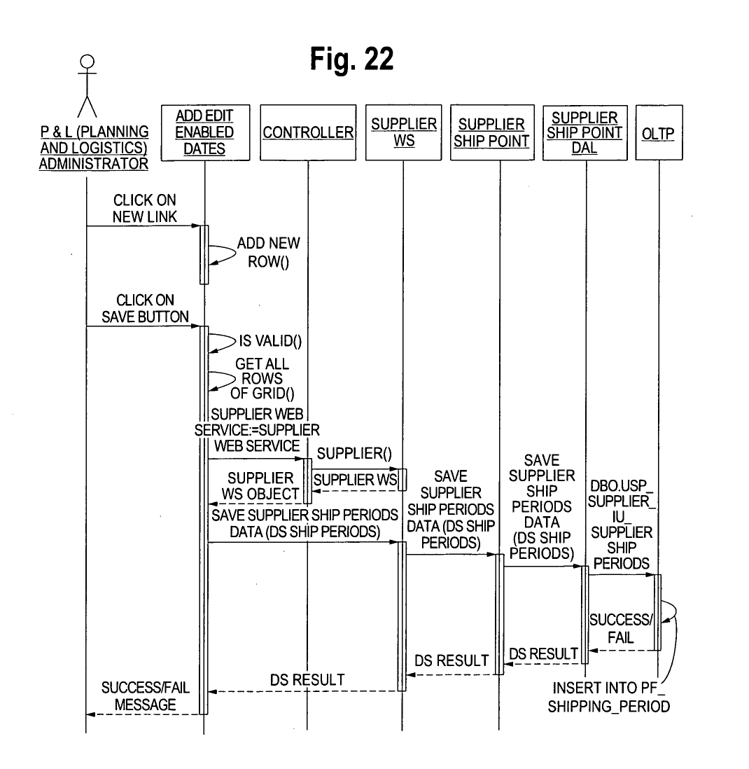

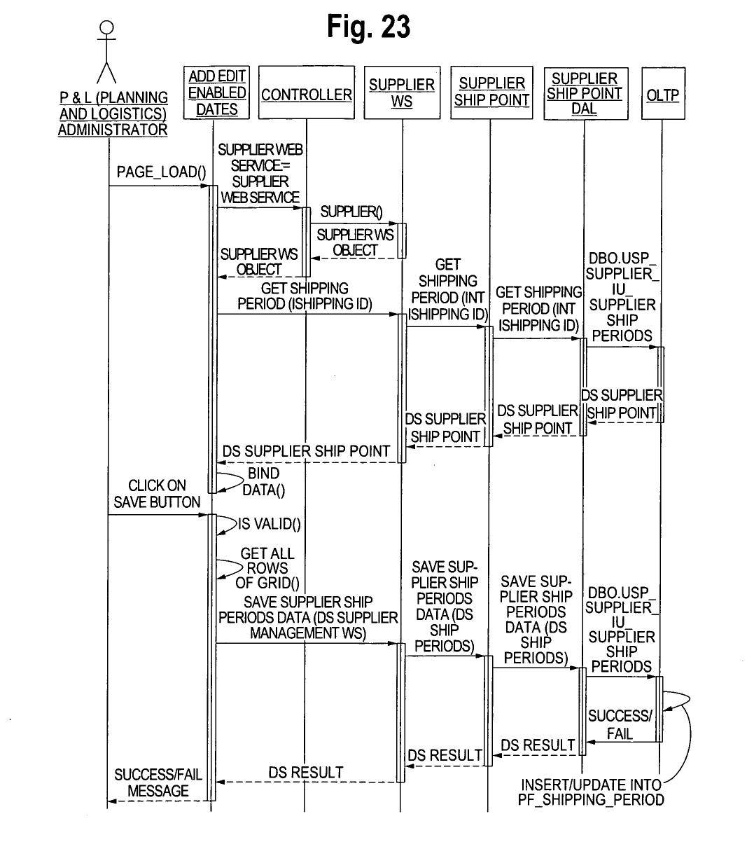

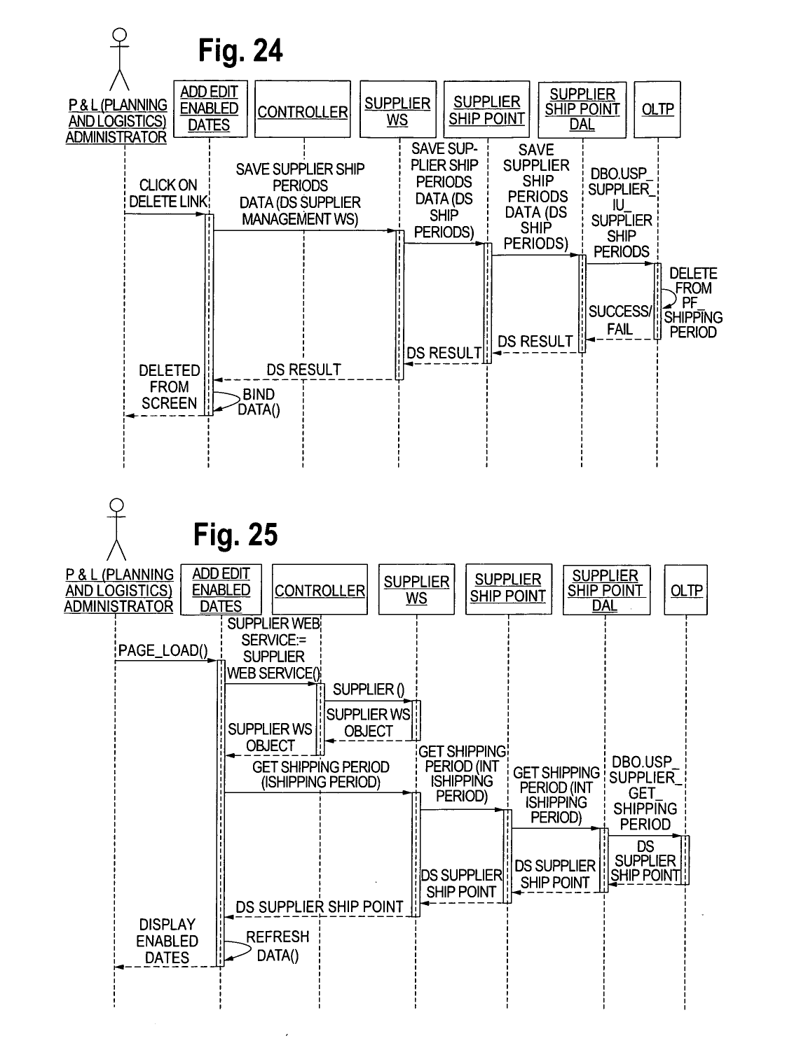

Turn now to FIGS. 11-25, commencing with Add/Edit Supplier.

When Supplier Management application is accessed, Add/Edit Supplier is the default screen.

The User can add a new supplier by selecting item “New Supplier” from Supplier combo, fill the required fields and clicks on “Save” button. The new supplier will be saved in the database.

The user selects any item from the Supplier combo, the corresponding data will be displayed in the fields, Update data and clicks on “Save” button the supplier will be updated.

User can cancel the changes.

From the Add/Edit Supplier, the user clicks on Add/Edit Ship Points link at the bottom of the screen, Add/Edit ShipPoint screen will be displayed.

In this screen: The User can add a new ship Point by selecting item “New Ship Point” from Ship Point combo; fill the required fields and clicks on “Save” button. The new ship point will be saved in the database.

The user selects any item from the Ship Point combo, the corresponding data will be displayed in the fields, then user Updates data and clicks on “Save” button the ship point details will be updated.

User can cancel the changes. The user clicks on Back button, the previous screen is displayed which is Add/Edit Supplier for this screen.

From the Add/Edit Supplier the user clicks on Add/Edit Shipping Records link at bottom of the screen, the Add/Edit Shipping Records screen will be displayed. In this screen: The user selects any item from the Supplier combo; the corresponding data will be displayed in the grid, which has the available ship point's details of the selected supplier.

At the bottom of the grid there is a “NEW” link, which is used to add new ship point to the selected supplier. On click of this link it will go to the next screen (Add/Edit Supplier Ship Point screen.)

Each row in the grid is having Edit link field, from which user can edit the ship point details. On click of this link it will go to the next screen (Add/Edit Shipping Record Details screen).

Each row in the grid consists of Enabled Periods link field, which shows the latest or next available enabled period or “Add” link. On click of this link, it will go to the next screen (Add/Edit Shipping Record Enabled Dates).

In this grid user can edit information about Priority, cutoff time, or can enable disable the ship point.
User can cancel the changes before saving.
User can save the changes into the database.
User can click on Back button which displays the Add/Edit Supplier Screen.
In the next screen Add/Edit Supplier's ship point screen,
User can add new relationship between supplier and ship point.
User can update exiting relationship between supplier and ship point.

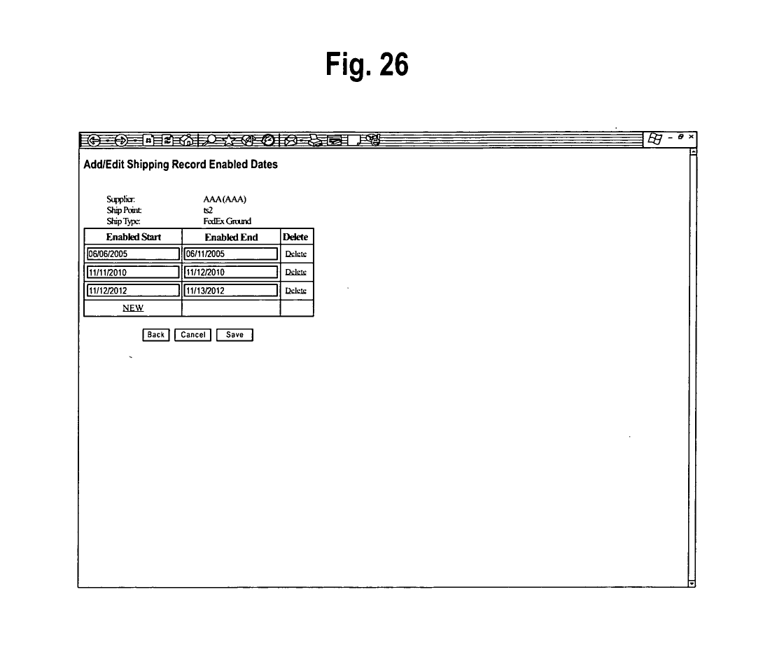

The Enabled Periods link shows the latest or next available enabled period or “Add” link. In case of add, this link will not be available. On click of this link, it will go to the next screen (Add/Edit Shipping Record Enabled Dates). See FIG. 26.
User can cancel the changes made in this screen.
User can save the changes into the database.
User can click on the Back button which will display the previous screen.

In the next screen (Edit Supplier's Ship Points Enabled Dates screen), This UI shows details of selected Shipping record in the labels and its enabled periods are displayed in a grid.

At the bottom of the grid there is “NEW” link, when user clicks on this a new row will be added to grid.

Each row contains delete link. Clicking on this link will delete corresponding enabled period from the database as well as from the grid shown in the screen.
User can cancel the changes made in this screen.
User can save the changes made into the database.
User can click on Back button which it will display the previous screen from which Edit Supplier's Ship Points Enabled Dates was called.

With regard to the code in the appendix, reference is made to the web service 6 and ASPX pages:
AddEditShipPoint.aspx, AddEditShipPoint.aspx.cs
AddEditSupplier.aspx, AddEditSupplier.aspx.cs
AddEditSupplierShipPoint.aspx, AddEditSupplierShipPoint.aspx.cs
AddEditEnabledDates.aspx, AddEditEnabledDates.aspx.cs
SupplierManagementBasePage.aspx, SupplierManagementBasePage.aspx.cs
SupplierShipPoints.aspx, SupplierShipPoints.aspx.cs
UnHandledException.aspx, UnHandledException.aspx.cs
User Controls:
UCContactDetail.ascx, UCContactDetail.ascx.cs
Class Files:
Supplier.asmx, Supplier.asmx,cs
As to the Business Layer:
Class Files:
SupplierBL.cs
ShipPoint.cs
SupplierShipPoint.CS
As to the data access layer:
Class Files:
SupplierDAL.cs
SupplierDALCache.cs
ShipPointDAL.cs
SupplierAndShipPointDAL.cs
Datasets
SupplierManagementDataSet
States
ZoneDataSet
SupplierforProductandShipDate
ResultDataset

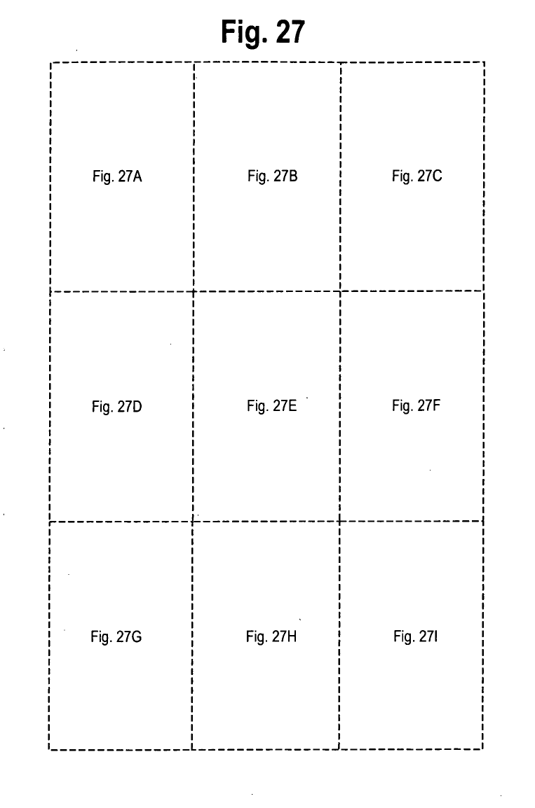

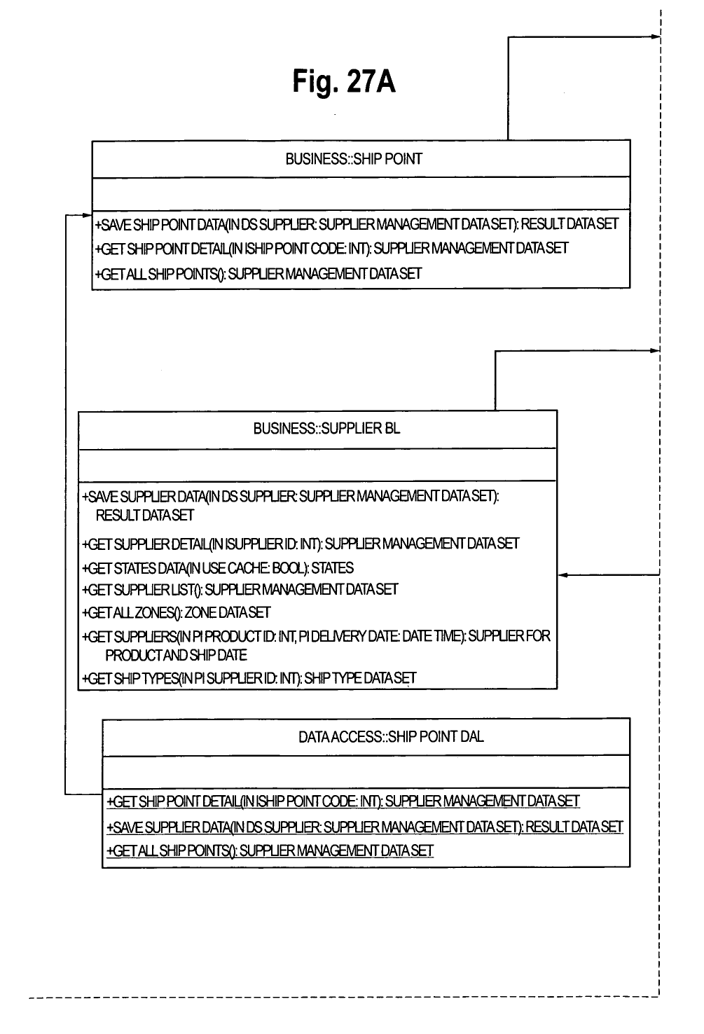

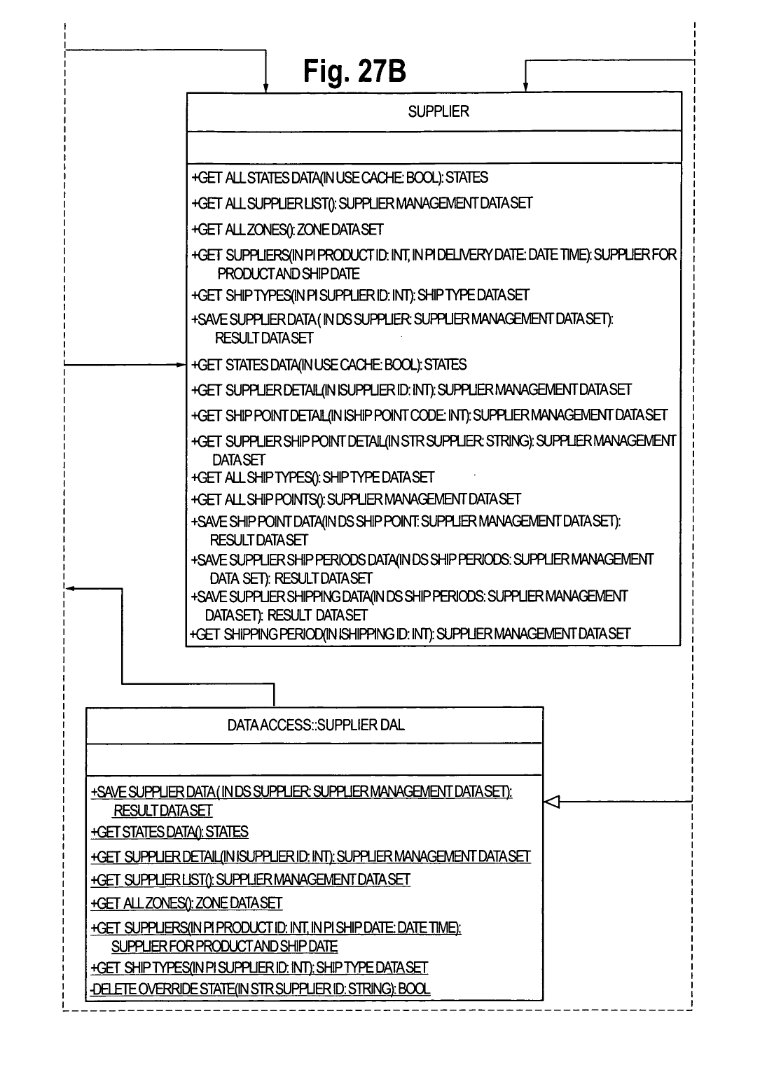

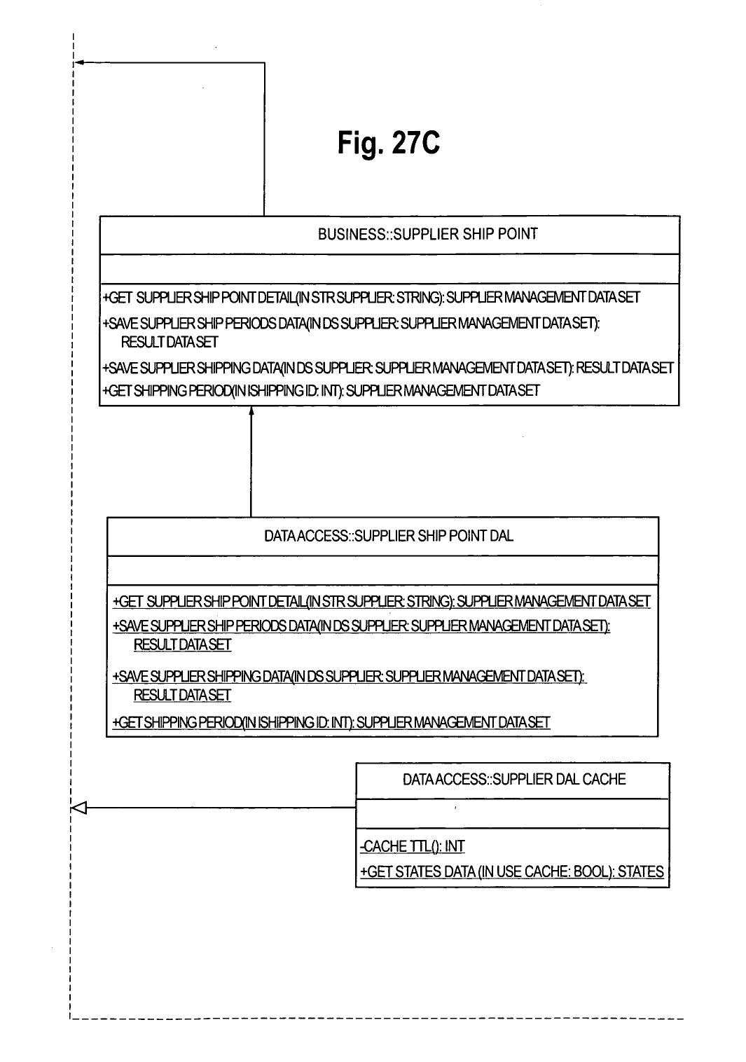

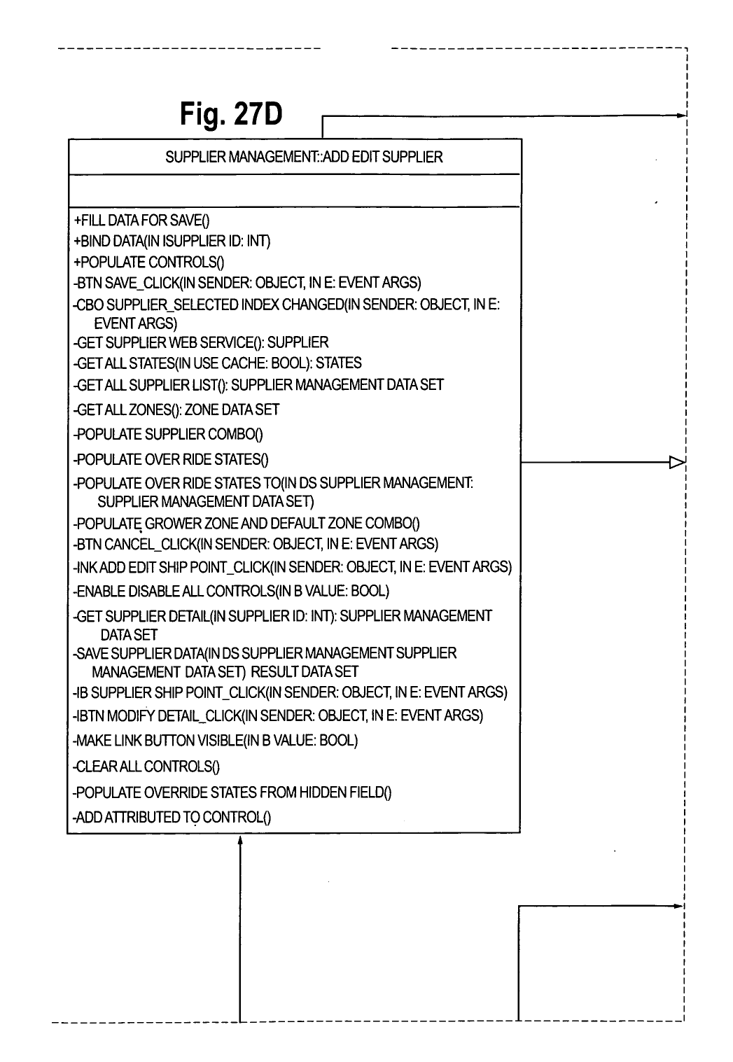

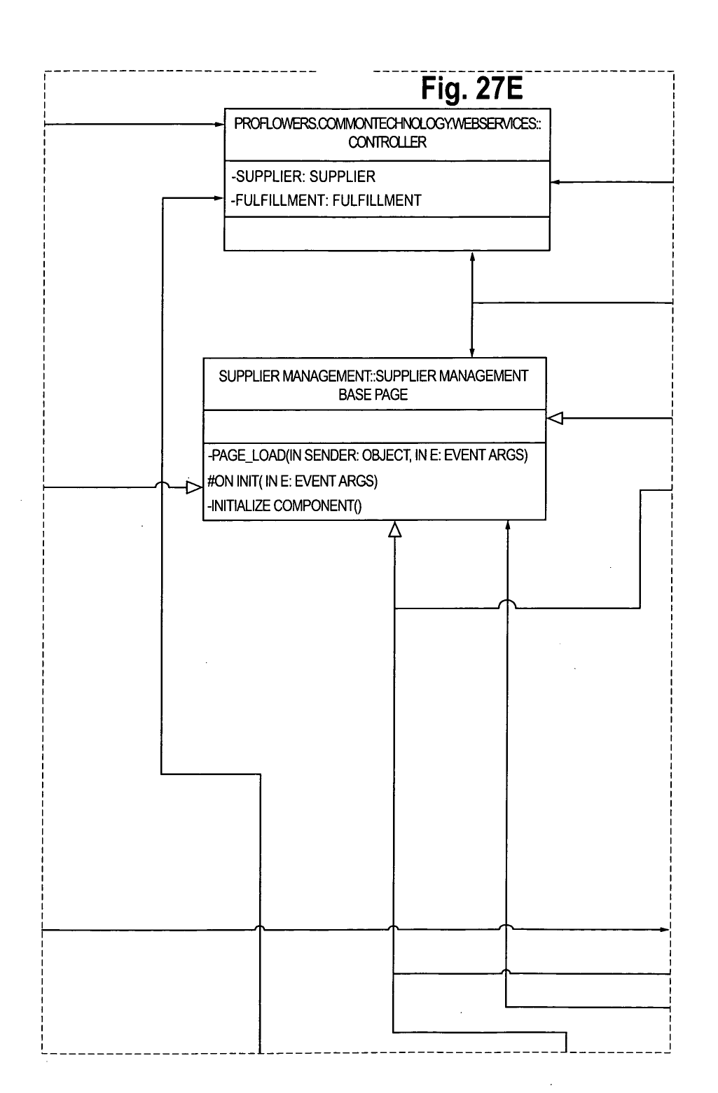

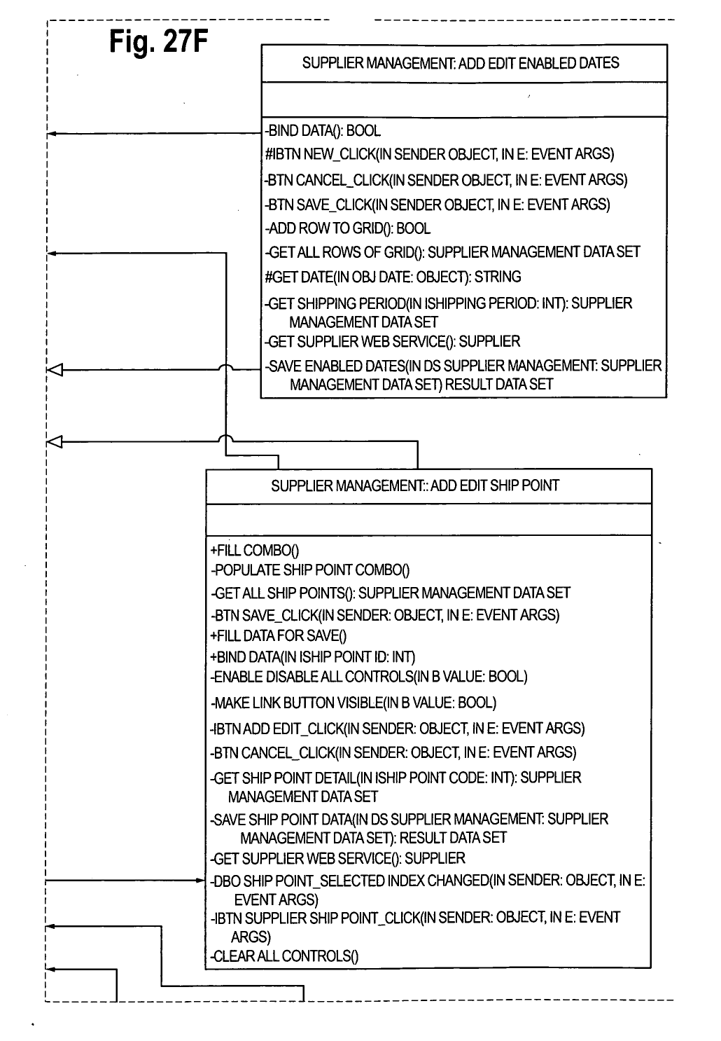

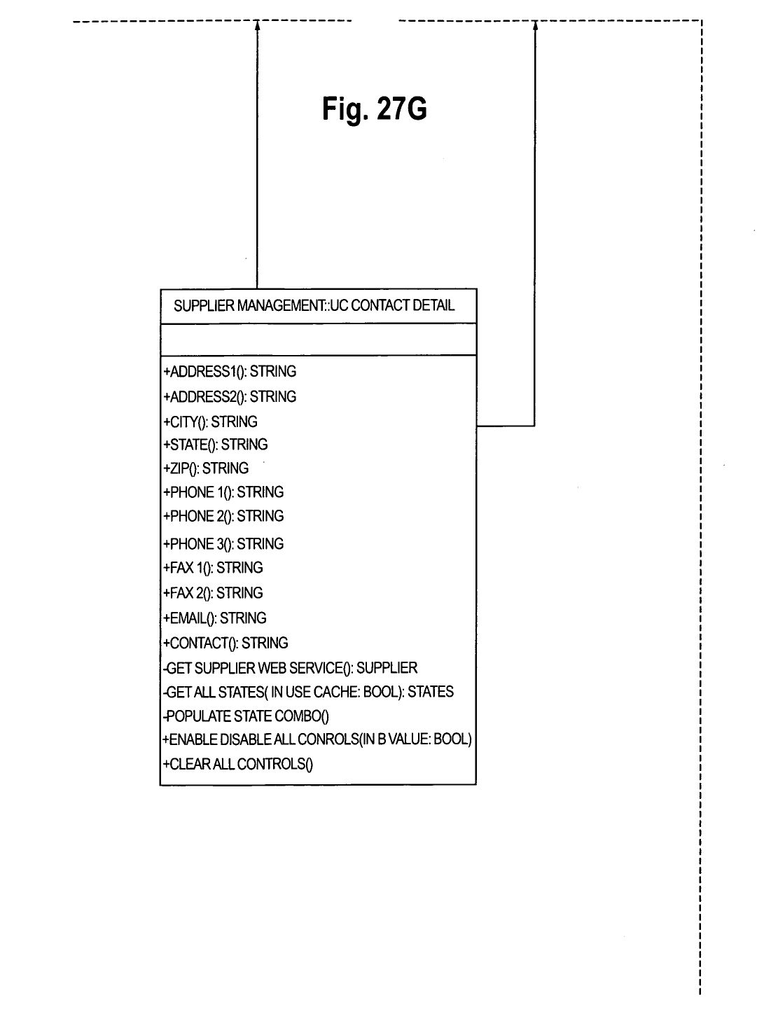

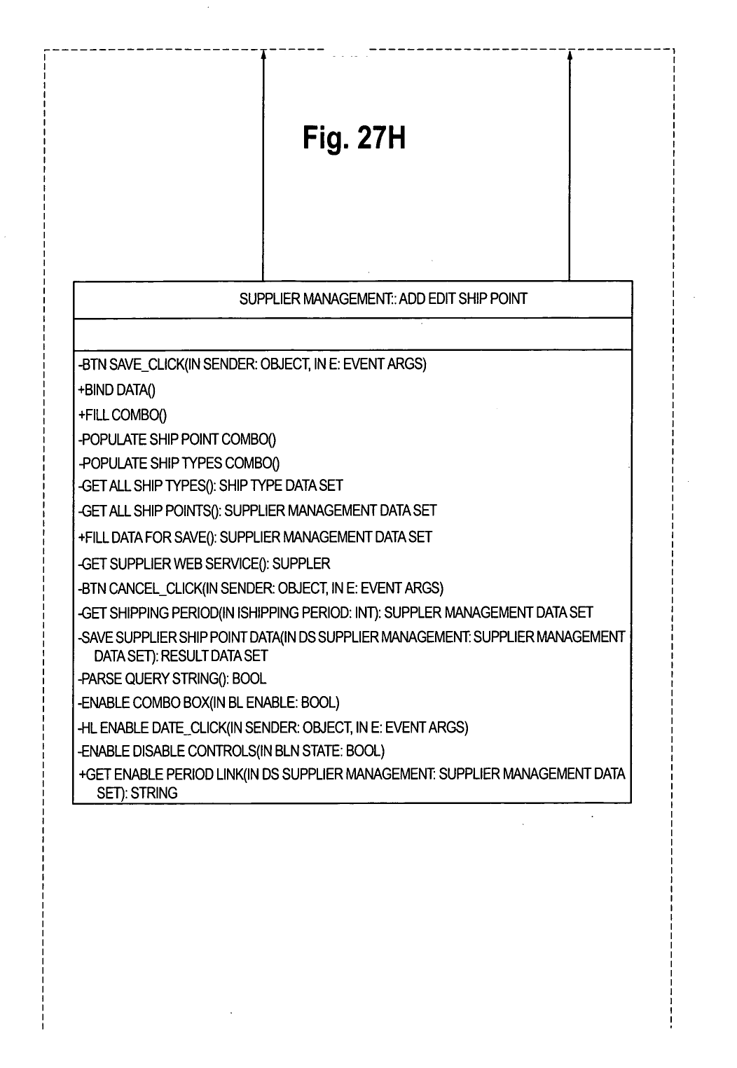

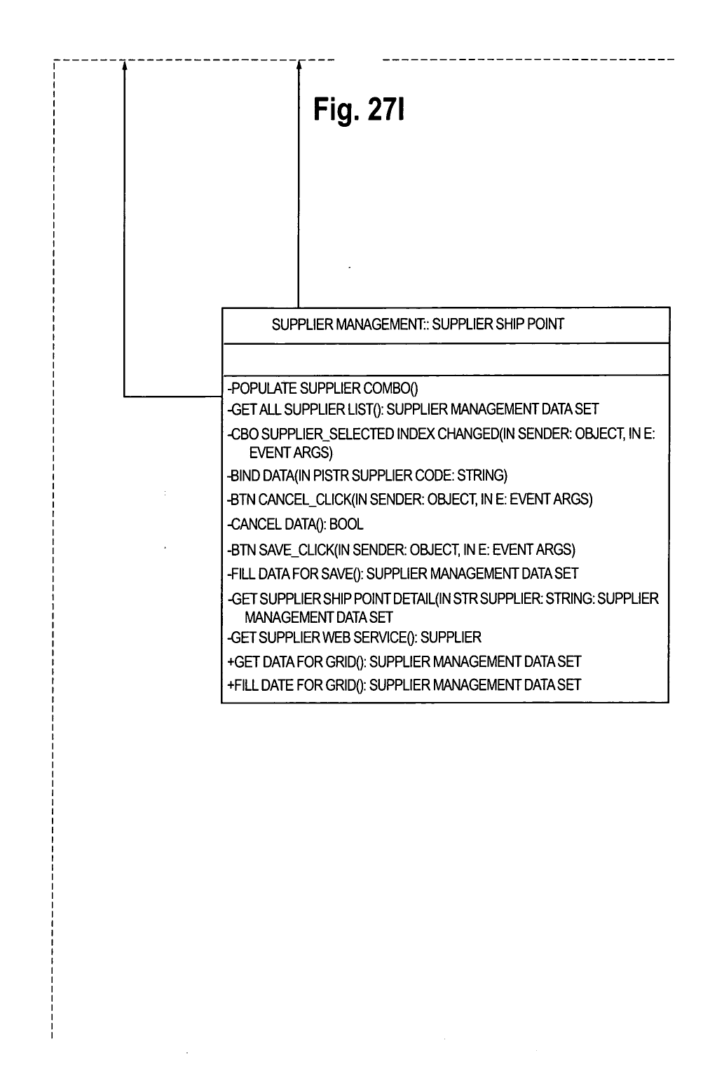

FIG. 27 represents a class diagram exemplifying an object model and gives an overview of the Supplier Management Application classes and their relations. Class descriptions are set forth below.
Class Name: AddEditShipPoint

Namespace: Application.Web.Fulfillment.SupplierManagement

| | Function | | | |
|---|---|---|---|---|
| Function Name | Scope | Arguments | Return Value | Description |
| BindData | Public | int | Void | Binds the data to the |
| | | | | control after selection of |
| | | | | supplier |
| ClearAllControls | Private | NA | Void | Clear all controls after |
| | | | | save |
| EnableDisableAll | Private | Bool | Void | Enable/Disable all controls |
| Controls | | | | after save |
| FillCombo | Public | NA | Void | Fill all the combo box |
| FillDataForsave | Public | NA | Void | Fill data in dataset before |
| | | | | save |
| GetAllShipPoints | Private | NA | Administration | Get all ShiPoints |
| | | | System.Business | |
| | | | Process.Fulfillment. | |
| | | | DataSets.Supplier | |
| | | | Management | |
| | | | DataSet | |
| GetShipPointDetail | Private | Int | Administration | Get Ship Point Details |
| | | | System.Business | |
| | | | Process.Fulfillment. | |
| | | | DataSets.Supplier | |
| | | | Management | |
| | | | DataSet | |
| GetSupplierWeb | Private | NA | Administration | Get instance of Supplier |
| Service | | | System.Application. | Management webservice |
| | | | WebServices. | |
| | | | Fulfillment.Supplier | |
| MakeLinkButton | Private | Bool | Void | make link buttons |
| Visible | | | | visible/invisible |
| PopulateShipPoint | Private | NA | Void | Populate Ship Point |
| Combo | | | | combo box |
| SaveShipPointData | Private | Administration | Administration | Save Ship Point Data |
| | | System.Business | System Business | |
| | | Process. | Process.Fulfillment. | |
| | | Fulfillment. | DataSets.Result | |
| | | DataSets. | Dataset | |
| | | Supplier | | |
| | | ManagementData | | |
| | | Set | | |
| btn Cancel_Click | Private | object, | Void | Clears the updated/ |
| | | System.Event | | changed data or refresh |
| | | Args | | from database. |
| btnSave_Click | Private | object, | Void | Saves the Ship Point data |
| | | System.Event | | to database |
| | | Args | | |
| cboShipPoint_Selected | Private | object, | Void | Gets the detail of selected |
| IndexChanged | | System.Event | | supplier |
| | | Args | | |
| lbtnAddEdit_Click | Private | object, | Void | Page is enabled for |
| | | System.Event | | Add/Edit |
| | | Args | | |
| lbtnSupplierShip | Private | object, | Void | Shows SupplierShipPoint |
| Point_Click | | System.Event | | page. |
| | | Args | | |
| btnBack_Click | Private | object, | void | Displays previous page. |
| | | System. | | |
| | | EventArgs | | |

Class Name: AddEditSupplier

Namespace: Application.Web.Fulfillment.SupplierManagement

| | Function | | | |
|---|---|---|---|---|
| Function Name | Scope | Arguments | Return Value | Description |
| AddAttributedTo | Private | NA | Void | Add attributes to controls |
| Control | | | | which will be executed on |
| | | | | client side |
| BindData | Public | Int | Void | Binds the data to the |
| | | | | control after selection of |
| | | | | supplier |
| ClearAllControls | Private | NA | Void | Clears all controls |
| EnableDisableAll | Private | Bool | Void | Enable/Disable all |
| Controls | | | | controls. |
| FillDataForsave | Public | NA | Void | Fill data into the dataset |
| GetAllSupplierList | Private | NA | Administration | Get All Supplier List from |
| | | | System.Business | database |
| | | | Process.Fulfillment. | |
| | | | DataSets.Supplier | |
| | | | Management | |
| | | | DataSet | |
| GetAllZones | Private | NA | Administration | Get All Zones from |
| | | | System.Business | database |
| | | | Process.Fulfillment. | |
| | | | DataSets.Zone | |
| | | | DataSet | |
| GetAllstates | Private | Bool | Administration | Get All US States from |
| | | | System.Business | database |
| | | | Process.Fulfillment. | |
| | | | DataSets.States | |
| GetSupplierDetail | Private | Int | Administration | Get Supplier Details |
| | | | System.Business | |
| | | | Process.Fulfillment. | |
| | | | DataSets.Supplier | |
| | | | Management | |
| | | | DataSet | |
| GetSupplierWeb | Private | NA | Administration | Get instance of Supplier |
| Service | | | System.Application. | Management web service |
| | | | WebServices. | |
| | | | Fulfillment.Supplier | |
| MakeLinkButton | Private | Bool | Void | make link buttons |
| Visible | | | | visible/invisible |
| PopulatOverRide | Private | NA | Void | Populate Override States |
| StatesFromHidden | | | | with selected values if |
| Field | | | | save of data fails. |
| PopulateControls | Public | NA | Void | Fill the combo boxes on |
| | | | | Page Load. |
| PopulateGrower | Private | NA | Void | Populate the grower zone |
| ZoneAndDefaultZone | | | | and Defaultzone combo |
| Combo | | | | boxes |
| PopulateOverRide | Private | NA | Void | Populates OverRide |
| States | | | | states |
| PopulateOverRide | Private | Administration | Void | Populating Override states |
| StatesTO | | System.Business | | To |
| | | Process. | | |
| | | Fulfillment. | | |
| | | DataSets. | | |
| | | Supplier | | |
| | | ManagementData | | |
| | | Set | | |
| PopulateSupplier | Private | NA | Void | Populate Supplier combo |
| Combo | | | | box |
| SaveSupplierData | private | Administra- | Administration | Save Supplier Data |
| | | tion | System.Business | |
| | | System.Business | Process.Fulfillment. | |
| | | Process. | DataSets.Result | |
| | | Fulfillment | Dataset | |
| | | DataSets | | |
| | | Supplier | | |
| | | ManagementData | | |
| | | Set | | |
| btnCancel_Click | Private | object, | Void | Clears the updated/ |
| | | System.Events | | changed data or refresh |
| | | Args | | from database. |
| btnSave_Click | Private | object, | Void | Used for saving the data |
| | | System.Events | | |
| | | Args | | |
| cboSupplier_Selected | Private | object, | Void | Binds the control with |
| IndexChanged | | System.Event | | suppliers data |
| | | Args | | |
| lbSupplierShip | Private | object, | Void | Transfer to Supplier's Ship |
| Point_Click | | System.Event | | Point |
| | | Args | | |
| lbtnModify | Private | object, | Void | Page in shown in Edit |
| Detail_Click | | System.Event | | mode |
| | | Args | | |
| InkAddEditShip | Private | object, | Void | Brings the page in |
| Point_Click | | System.Event | | Add/Edit mode |
| | | Args | | |

Class Name: AddEditSupplierShipPoint

Namespace: Application.Web.Fulfillment.SupplierManagement

| | Function | | | |
|---|---|---|---|---|
| Function Name | Scope | Arguments | Return Value | Description |
| Bind Data | Public | Int | Void | Binds the data to the |
| | | | | control after selection of |
| | | | | supplier |
| ClearControls | Private | NA | void | Clearing controls |
| EnableComboBox | Private | Bool | void | set Enable/Disable combo |
| | | | | boxes |
| EnableDisableAll | Private | Bool | Void | Enable/Disable all controls |
| Controls | | | | after save |
| FillCombo | Public | NA | Void | Used for filling the |
| | | | | comboboxes |
| FillDataForsave | Public | NA | Administration | Fill Data for Save |
| | | | System.Business | |
| | | | Process.Fulfillment. | |
| | | | DataSets.Supplier | |
| | | | Management | |
| | | | DataSet | |
| GetAllShipPoints | Private | NA | Administration | Get all Ship Points |
| | | | System.Business | |
| | | | Process.Fulfillment. | |
| | | | DataSets.Supplier | |
| | | | Management | |
| | | | DataSet | |
| GetAllShipTypes | Private | NA | ShipTypeDataSet | Get All Ship Types |
| GetEnabledPeriod | Public | Administra- | string | Getting Enable Period |
| Link | | tion | | Link for selected record |
| | | System.Business | | |
| | | Process. | | |
| | | Fulfillment. | | |
| | | DataSets. | | |
| | | Supplier | | |
| | | ManagementData | | |
| | | Set | | |
| GetShippingPeriod | Private | Int | Administration | Get details of Supplier |
| Data | | | System.Business | ship point based on |
| | | | Process.Fulfillment. | ShippingID |
| | | | DataSets.Supplier | |
| | | | Management | |
| | | | DataSet | |
| GetSupplierWeb | Private | NA | Administration | Get instance of Supplier |
| Service | | | System.Application. | Management web service |
| | | | WebServices. | |
| | | | Fulfillment.Supplier | |
| hlEnableDate_Click | Private | NA | Void | Transfers to |
| | | | | AddEditEnabledDate.aspx |
| | | | | page |
| ParseQueryString | Private | NA | bool | Parsing query string to |
| | | | | determine New/Edit |
| PopulateShipPoint | Private | NA | Void | Fill Ship Point combo |
| Combo | | | | |
| PopulateShipType | Private | NA | Void | Fill Ship Type Combo |
| ombo | | | | |
| RefreshData | private | NA | void | Refresh Supplier Ship |
| | | | | Point data |
| SaveSupplierShip | Private | Administra- | Administration | Save Supplier Shipping |
| PointData | | tion | System.Business | Data |
| | | System. | Process.Fulfillment. | |
| | | BusinessProcess. | DataSets.Result | |
| | | Fulfillment. | Dataset | |
| | | DataSets. | | |
| | | Supplier | | |
| | | ManagementData | | |
| | | Set | | |
| btnBack_Click | Private | Object, | void | Go to previous page |
| | | System.Event | | |
| | | Args | | |
| btnCancel_Click | Private | object, | Void | Clears the updated/ |
| | | System.Event | | changed data or refresh |
| | | Args | | from database. |
| btnSave_Click | Private | object, | Void | Save Supplier's Ship Point |
| | | System.Event | | data |
| | | Args | | |

Class Name: SupplierShipPoints

Namespace: Application.Web.Fulfillment.SupplierManagement

| | Function | | Return | |
|---|---|---|---|---|
| Function Name | Scope | Arguments | Value | Description |
| BindData | Public | string | Void | Used to bind the data |
| FillDataForsave | Public | NA | Void | Used to fill dataset for |
| | | | | saving |
| FillDateForGrid | Public | NA | Void | Get recent or next |
| | | | | available enable period. If |
| | | | | not available then returns |
| | | | | “ADD”. |
| GetAllSupplierList | Private | NA | Adminis- | Get All Supplier List from |
| | | | tration | database |
| | | | System. | |
| | | | Business | |
| | | | Process. | |
| | | | Fulfillment | |
| | | | DataSets. | |
| | | | Supplier | |
| | | | Management | |
| | | | DataSet | |
| GetDataForGrid | Public | NA | Supplier | Get the data table for grid |
| | | | Management | |
| | | | DataSet | |
| GetSupplierShip | Private | string | Adminis- | Get Supplier Ship Point |
| PointDetail | | | tration | Details |
| | | | System. | |
| | | | Business | |
| | | | Process. | |
| | | | Fulfillment. | |
| | | | DataSets. | |
| | | | Supplier | |
| | | | Management | |
| | | | DataSet | |
| GetSupplierWeb | Private | NA | Adminis- | Get instance of Supplier |
| Service | | | tration | Management web service |
| | | | System. | |
| | | | Application. | |
| | | | Web | |
| | | | Services | |
| | | | Fulfillment. | |
| | | | Supplier | |
| CancelData | Private | NA | bool | Clears the updated/ |
| | | | | changed data or refresh |
| | | | | from database. |
| RefreshData | Private | NA | void | Refreshing Grid from |
| | | | | database |
| cboSupplier_Selected | Private | object | void | Binds the data to control |
| IndexChanged | | System.EventArgs | | after supplier is selected |
| PopulateSupplier | Private | NA | void | Populate Supplier combo |
| Combo | | | | box |
| btnBack_Click | Private | object, | void | Displays Add/Edit supplier |
| | | System.EventArgs | | page. |
| btnCancel_Click | Private | object, | Void | Cancel the changes |
| | | System.EventArgs | | |
| btnSave_Click | Private | object, | Void | Saves the |
| | | System.EventArgs | | SupplierShipPoint data to |
| | | | | database |
| grdSupplierShip | Private | Object, | void | used for formatting Fields |
| Points_ItemDataBound | | System.Web.UI. | | |
| | | WebControls.Data | | |
| | | GridItemEventArgs | | |

Class Name: AddEditEnabledDates

Namespace: Application.Web.Fulfillment.SupplierManagement

| | Function | | | |
|---|---|---|---|---|
| Function Name | Scope | Arguments | Return Value | Description |
| AddRowToGrid | Private | NA | bool | Add new blank row in data |
| | | | | grid |
| BindData | private | NA | bool | Bind the detail to the |
| | | | | controls |
| GetAllRowsOfGrid | Private | NA | SupplierManagement | Read value of all controls |
| | | | DataSet | of all rows from the grid. |
| GetDate | protected | object | string | Gets the date in |
| | | | | “MM/dd/yyyy” format |
| GetShippingPeriod | Private | int | Administration | Get Ship Period Details |
| | | | System.Business | |
| | | | Process.Fulfillment. | |
| | | | DataSets.Supplier | |
| | | | Management | |
| | | | DataSet | |
| GetSupplierWeb | private | NA | Administration | Get instance of Supplier |
| Service | | | System.Application. | Management web service |
| | | | WebServices. | |
| | | | FulfillmentWeb | |
| | | | Service.Supplier | |
| IsNewRow | protected | object | bool | Check for new row. |
| IsOverlappingDate | Private | NA | string | Checks for overlapping |
| | | | | dates |
| NewRowColor | protected | object | Color | Show different border |
| | | | | color for new row in grid. |
| RefreshData | Private | NA | void | Refreshing data |
| SaveEnabledDates | Private | Administra- | Administration | Save Enabled Dates |
| | | tion | System.Business | |
| | | System.Business | Process.Fulfillment. | |
| | | Process. | DataSets.Supplier | |
| | | Fulfillment. | Management | |
| | | DataSets. | DataSet | |
| | | ResultDataset | | |
| btnBack_Click | Private | Object, | void | Go to previous page |
| | | System.Event | | |
| | | Args | | |
| btnCancel_Click | Private | object, | Void | Clears the updated/ |
| | | System.Event | | changed data or refresh |
| | | Args | | from database. |
| btnSave_Click | Private | object, | Void | Save the data into |
| | | System.Event | | database |
| | | Args | | |
| lbtnNew_Click | protected | object, | void | Add new blank row to the |
| | | System.Event | | data grid |
| | | Args | | |
| lbtnDeleteEnabled | protected | Object, | void | Delete enable date from |
| Period | | Command | | database |
| | | EventArgs | | |

Class Name: UnHandledException

Namespace: Application.Web.Fulfillment.SupplierManagement

| | Function | | Return | |
|---|---|---|---|---|
| Function Name | Scope | Arguments | Value | Description |
| _continueButton_{—} | Private | NA | Void | Redirects to Add/Edit |
| ServerClick( ) | | | | supplier page |
| btnBack_Click | Private | Object, | void | Go to previous page |
| | | System.EventArgs | | |

Class Name: UCContactDetail

Namespace: Application.Web.Fulfillment.DataAccess

| | Function | | | |
|---|---|---|---|---|
| Function Name | Scope | Arguments | Return Value | Description |
| GetSupplierWeb | Private | NA | Administration | Get instance of Supplier |
| Service | | | System.Application. | Management web service |
| | | | WebServices. | |
| | | | FulfillmentWeb | |
| | | | Service.Supplier | |
| GetAllstates | Private | bool | Administration | Get All US States from |
| | | | System.Business | database |
| | | | Process.Fulfillment. | |
| | | | DataSets.States | |
| PopulateState | Private | NA | void | Populate State combo box |
| Combo | | | | |
| EnableDisableAll | Public | bool | Void | Enable/disable all controls |
| Controls | | | | |
| ClearAllControls | Public | NA | void | Clear all controls |

Class Name: SupplierBL

Namespace: BusinessProcess.Fulfillment.Bussiness

| | Function | | | |
|---|---|---|---|---|
| Function Name | Scope | Arguments | Return Value | Description |
| SaveSupplierData | Public | Supplier | ResultDataset | Save the supplier data |
| | | Management | | |
| | | DataSet | | |
| GetSupplierDetail | public | int | SupplierManagement | Gets Supplier detail |
| | | | DataSet | |
| GetStatesData | public | bool | States | Get All States |
| GetSupplierList | Public | NA | SupplierManagement | Get list of suppliers |
| | | | DataSet | |
| GetAllZones | Public | NA | ZoneDataSet | Get all grower zones and |
| | | | | default zones |
| GetShipTypes | public | int | ShipTypeDataSet | Get Carrier Types for a |
| | | | | given supplier |

Class Name: ShipPoint

Namespace: BusinessProcess.Fulfillment.Bussiness

| | Function | | | |
|---|---|---|---|---|
| Function Name | Scope | Arguments | Return Value | Description |
| SaveShipPointData | Public | Supplier | ResultDataset | Save the ShipPoint data |
| | | Management | | |
| | | DataSet | | |
| GetShipPointDetail | public | int | SupplierManagement | Gets ShipPoint detail |
| | | | DataSet | |
| GetAllShipPoints | Public | NA | SupplierManagement | Get list of ShipPoints |
| | | | DataSet | |

Class Name: SupplierShipPoint

Namespace: BusinessProcess.Fulfillment.Bussiness

| | Function | | | |
|---|---|---|---|---|
| Function Name | Scope | Arguments | Return Value | Description |
| GetSupplierShip | public | string | SupplierManagement | Get list of Supplier's for |
| PointDetail | | | DataSet | Edit Supplier Ship Point |
| SaveSupplierShip | Public | Supplier | ResultDataset | Call DAL method in |
| PeriodsData | | Management | | SupplierShipPointDAL |
| | | DataSet | | |
| SaveSupplier | Public | Supplier | ResultDataset | Save Supplier Shipping |
| ShippingData | | Management | | data |
| | | DataSet | | |
| GetShipping | public | int | SupplierManagement | Get detail for shipping |
| Period | | | DataSet | period |

Class Name: SupplierDAL

Namespace: BusinessProcess.Fulfillment.DataAccess

| | Function | | | |
|---|---|---|---|---|
| Function Name | Scope | Arguments | Return Value | Description |
| SaveSupplierData | Public | Supplier | ResultDataset | Save the supplier |
| | | Management | | details in the database |
| | | DataSet | | |
| GetStatesData | Public | NA | States | Gets states |
| GetSupplierDetail | Public | int | SupplierManagement | Gets Supplier detail |
| | | | DataSet | |
| GetSupplierList | Public | NA | SupplierManagement | Get list of suppliers |
| | | | DataSet | |
| GetAllZones | Public | NA | ZoneDataSet | Get list of default zone |
| | | | | and grower zone. |
| GetShipTypes | Public | int | ShipTypeDataSet | Get all carrier types |
| DeleteOverrideState | Private | string | bool | Delete Existing |
| | | | | Override States for |
| | | | | supplier |

Class Name: ShippointDAL

Namespace: BusinessProcess.Fulfillment.DataAccess

| | Function | | | |
|---|---|---|---|---|
| Function Name | Scope | Arguments | Return Value | Description |
| GetShipPointDetail | Public | int | SupplierManagement | Gets details of ShipPoint |
| | | DataSet | | |
| SaveShipPointData | public | Supplier | ResultDataset | Used to save the |
| | | Management | | ShipPoint details in the |
| | | DataSet | | database |
| GetAllShipPoints | Public | | SupplierManagement | Gets All Ship Points |
| | | | DataSet | |

Class Name: SupplierDALCache

Namespace BusinessProcess.Fulfillment.DataAccess

| | Function | | | |
|---|---|---|---|---|
| Function Name | Scope | Arguments | Return Value | Description |
| GetStatesData | Public | bool | States | Overloads the GetStatesData |
| | | | | of base class SupplierDAL. |

Class Name: Supplier

Namespace: Application.WebServices.Fulfillment

| | Function | | | |
|---|---|---|---|---|
| Function Name | Scope | Arguments | Return Value | Description |
| GetAllStates | Public | bool | States | Return list of US states. |
| GetAllSupplierList | public | | Administration | Get all suppliers |
| | | | System.Business | |
| | | | Process.Fulfillment. | |
| | | | DataSets.Supplier | |
| | | | Management | |
| | | | DataSet | |
| GetAllZones | Public | | Administration | Get all grower zones and |
| | | | System.Business | default zones |
| | | | Process.Fulfillment. | |
| | | | DataSets.Zone | |
| | | | DataSet | |
| GetAllShipTypes | public | int | roflowers.Business | Get All Ship Types |
| | | | Process.Fulfillment | |
| | | | DataSets.Ship | |
| | | | TypeDataSet | |
| GetSupplierDetail | Public | int | Administration | Get Supplier Details from |
| | | | System.Business | database |
| | | | Process.Fulfillment. | |
| | | | DataSets.Supplier | |
| | | | Management | |
| | | | DataSet | |
| GetShipPointDetail | public | int | Administration | Get ShipPoint Details from |
| | | | System.Business | database |
| | | | Process.Fulfillment. | |
| | | | DataSets.Supplier | |
| | | | Management | |
| | | | DataSet | |
| GetSupplierShip | Public | string | Administration | Get Supplier'sShipPoint |
| PointDetail | | | System.Business | Details from database |
| | | | Process.Fulfillment. | |
| | | | DataSets.Supplier | |
| | | | Management | |
| | | | DataSet | |
| GetShippingPeriod | public | int | public | Get Shipping Period detail |
| | | | Administration | |
| | | | System.Business | |
| | | | Process.Fulfillment. | |
| | | | DataSets.Supplier | |
| | | | Management | |
| | | | DataSet | |
| SaveSupplierData | Public | Administration | Administration | Add/Update Supplier |
| | | System. | System.Business | |
| | | BusinessProcess. | Process.Fulfillment. | |
| | | Fulfillment. | DataSets.Result | |
| | | DataSets. | Dataset | |
| | | Supplier | | |
| | | ManagementData | | |
| | | Set | | |
| SaveShipPointData | Public | Administration | Administration | Add/update ShipPoint |
| | | System.Business | System.Business | |
| | | Process. | Process.Fulfillment. | |
| | | Fulfillment. | DataSets.Result | |
| | | DataSets. | Dataset | |
| | | Supplier | | |
| | | ManagementData | | |
| | | Set | | |
| SaveSupplierShip | public | Administration | Administration | Calls |
| PeriodsData | | SystemBusiness | System.Business | SaveSupplierShipPeriods |
| | | Process. | Process.Fulfillment. | Data BL method |
| | | Fulfillment. | DataSets.Result | |
| | | DataSets. | Dataset | |
| | | Supplier | | |
| | | ManagementData | | |
| | | Set | | |
| SaveSupplier | Public | Administration | Administration | Calls |
| ShippingData | | System.Business | System.Business | SaveSupplierShippingData |
| | | Process. | Process.Fulfillment. | BL method |
| | | Fulfillment. | DataSets.Result | |
| | | DataSets. | Dataset | |
| | | Supplier | | |
| | | ManagementData | | |
| | | Set | | |

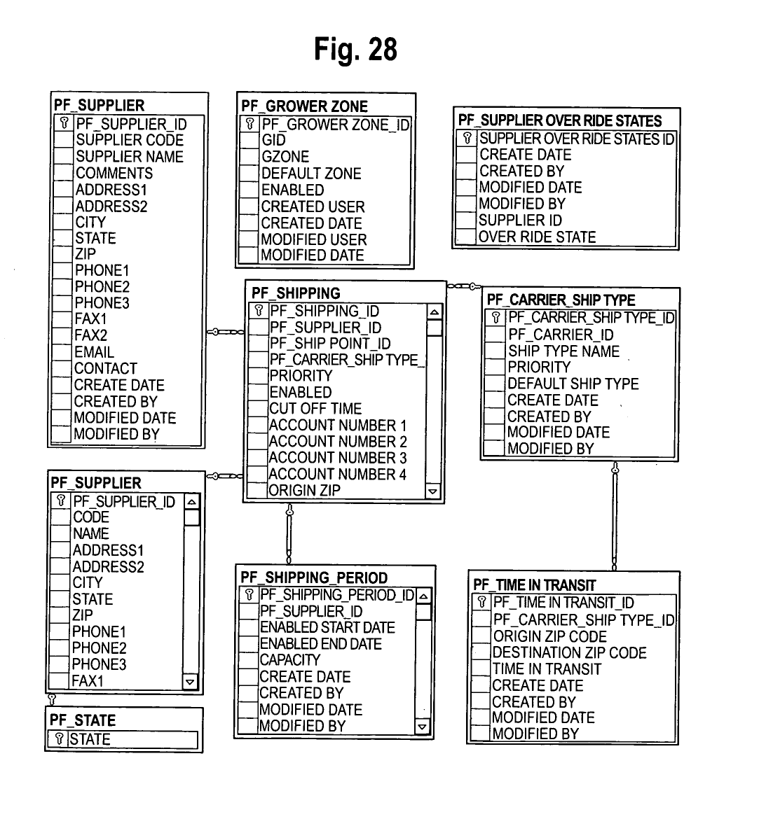

With regard to the management application database, see the diagram in FIG. 28. The following represent user tables.

| Object Type | Object Name | Description |
|---|---|---|
| User Table | ADMINISTRATION | Information about Enabled periods for |
| | SYSTEM_Shipping Period | Supplier's ShipPoint which is stored in |
| | | ADMINISTRATION SYSTEM_Shipping |
| | | table |
| User Table | ADMINISTRATION | This table holds the data related to ship |
| | SYSTEM_ShipPoint | point. |
| User Table | ADMINISTRATION | It stores the Grower Zone and default zone |
| | SYSTEM_GrowerZone | information for suppliers. |
| User Table | ADMINISTRATION | Contains Supplier's details. |
| | SYSTEM_Supplier | |
| User Table | ADMINISTRATION | Contains list of states in USA. |
| | SYSTEM_State | |
| User Table | ADMINISTRATION | Contains details of relationship between |
| | SYSTEM_Shipping | supplier and ship point. |
| User Table | ADMINISTRATION | Contains details of override states for |
| | SYSTEM_SupplierOverRide | suppliers |
| | States | |
| User Table | ADMINISTRATION | Contains details of Ship types. |
| | SYSTEM_Carrier_ShipType | |

The following can be stored procedures:

| Object | | | | | |
|---|---|---|---|---|---|
| Type | File Name | Object Name | Parameters | Returns | Description |
| Stored | dbo.Usp_{—} | dbo.Usp_Supplier_{—} | SupplierId, | | This proc will |
| Procedure | Supplier_{—} | d_OverRide | OverRideState | | delete all |
| | d_OverRide | States | | | override states |
| | States | | | | in |
| | | | | | ADMINISTRATION |
| | | | | | SYSTEM_override |
| | | | | | states table |
| | | | | | for specified |
| | | | | | Supplier |
| Stored | dbo.Usp_{—} | dbo.Usp_Supplier_{—} | ShippingID | | This proc will |
| Procedure | Supplier_{—} | d_Shipping | | | delete |
| | d_Shipping | | | | Supplier's Ship |
| | | | | | Point from |
| | | | | | ADMINISTRATION |
| | | | | | SYSTEM_Shipping |
| | | | | | Table |
| Stored | dbo.Usp_{—} | dbo.Usp_Supplier_{—} | SupplierCode | | This proc will |
| Procedure | Supplier_{—} | d_Supplier | | | delete Supplier |
| | d_Supplier | | | | from |
| | | | | | ADMINISTRATION |
| | | | | | SYSTEM_Supplier |
| | | | | | table |
| Stored | dbo.Usp_{—} | dbo.Usp_Supplier_{—} | ADMINISTRATION | | This proc will |
| Procedure | Supplier_{—} | d_Supplier | SYSTEM | | delete Shipping |
| | d_Supplier | ShipPeriods | ShippingID | | Period from |
| | ShipPeriods | | | | ADMINISTRATION |
| | | | | | SYSTEM_{—} |
| | | | | | Shipping_Period |
| | | | | | table |
| Stored | dbo.Usp_{—} | Usp_Supplier_{—} | NA | ADMINISTRATION | This proc |
| Procedure | Supplier_{—} | get_States | | SYSTEM_{—} | returns States |
| | get_States. | | | States | for |
| | PRC | | | | States Combo |
| | | | | | Box |
| Stored | dbo.Usp_{—} | dbo.Usp_Supplier_{—} | NA | ADMINISTRATION | This proc |
| Procedure | Supplier_{—} | get_Supplier | | SYSTEM_ | returns Supplier |
| | get_Supplier | List | | Supplier | List From |
| | List.PRC | | | | ADMINISTRATION |
| | | | | | SYSTEM_{—} |
| | | | | | Supplier Table |
| Stored | dbo.Usp_{—} | dbo.Usp_Supplier_{—} | SupplierID | | This proc |
| Procedure | Supplier_{—} | get_Supplier | | | returns Supplier |
| | get_{—} | | | | Detail From |
| | Supplier.PRC | | | | ADMINISTRATION |
| | | | | | SYSTEM_{—} |
| | | | | | Supplier Table |
| Stored | dbo.Usp_{—} | dbo.Usp_Supplier | NA | | This proc |
| Procedure | Supplier_{—} | get_Grower | | | returns Grower |
| | get_{—} | Zone | | | Zone States for |
| | GrowerZone. | | | | Grower Zone |
| | PRC | | | | Combo box |
| Stored | dbo.Usp_{—} | dbo.Usp_Supplier_{—} | NA | | This proc |
| Procedure | Supplier_{—} | get_Default | | | returns Default |
| | get_Default | Zone | | | Zone for Default |
| | Zone.PRC | | | | Zone Combo |
| | | | | | box. |
| Stored | dbo.Usp_{—} | dbo.Usp_Supplier_{—} | NA | | This proc |
| Procedure | Supplier_{—} | get_Ship | | | returns |
| | get_Ship | PointList | | | SupplierID all |
| | PointList. | | | | ShipPoint |
| | PRC | | | | From |
| | | | | | ADMINISTRATION |
| | | | | | SYSTEM_Ship |
| | | | | | Point Table |
| Stored | dbo.Usp_{—} | dbo.Usp_Supplier_{—} | ShipPointID | | This proc will |
| Procedure | Supplier_{—} | get_ShipPoint | | | select ShipPoint |
| | get_Ship | | | | Detail |
| | Point.PRC | | | | |
| Stored | dbo.Usp_{—} | dbo.Usp_Supplier | ShippingID | | This proc |
| Procedure | Supplier_{—} | get_Shipping | | | returns |
| | get_Shipping | Period | | | Shipping_period |
| | Period | | | | detail, |
| | | | | | Shipping |
| | | | | | details, |
| | | | | | From |
| | | | | | ADMINISTRATION |
| | | | | | SYSTEM_Supplier, |
| | | | | | ADMINISTRATION |
| | | | | | SYSTEM_Shipping |
| | | | | | ADMINISTRATION |
| | | | | | SYSTEM_SHIP |
| | | | | | POINT, |
| | | | | | ADMINISTRATION |
| | | | | | SYSTEM_{—} |
| | | | | | SUPPLIER, |
| | | | | | ADMINISTRATION |
| | | | | | SYSTEM_Carrier_{—} |
| | | | | | ShipType |
| | | | | | Tables |
| Stored | dbo.Usp_{—} | dbo.Usp_Supplier_{—} | SupplierCode | | This proc will |
| Procedure | Supplier_{—} | get_Supplier | | | select Supplier |
| | get_Supplier | ShipPointDetail | | | and ShipPoint |
| | ShipPoint | | | | Detail From |
| | Detail.PRC | | | | ADMINISTRATION |
| | | | | | SYSTEM_Supplier, |
| | | | | | ADMINISTRATION |
| | | | | | SYSTEM_Shipping, |
| | | | | | ADMINISTRATION |
| | | | | | SYSTEM_Ship |
| | | | | | PointTable |
| | | | | | ADMINISTRATION |
| | | | | | SYSTEM_Carrier_{—} |
| | | | | | ShipType |
| | | | | | Table |
| Stored | dbo.usp_{—} | dbo.usp_Fulfill- | SupplierId | | This proc will |
| Procedure | Fulfillment_{—} | ment_GetSupplier | | | select Available |
| | GetSupplier | ShipTypes | | | Ship Types |
| | ShipTypes. | | | | FOR |
| | PRC | | | | SELECTED |
| | | | | | supplier If |
| | | | | | supplier id is |
| | | | | | passed as null |
| | | | | | then all ship |
| | | | | | types will be |
| | | | | | returned. |
| Stored | dbo.Usp_{—} | dbo.Usp_Supplier_{—} | SupplierID, | Supplier | This proc will |
| Procedure | Supplier_{—} | iu_Supplier | SupplierCode, | ID | insert Supplier |
| | iu_Supplier. | | SupplierName, | | in to |
| | PRC | | Comments, | | ADMINISTRATION |
| | | | Address1, | | SYSTEM_Supplier |
| | | | Address2, | | table |
| | | | City, | | |
| | | | State, | | |
| | | | Zip, | | |
| | | | Phone1, | | |
| | | | Phone2, | | |
| | | | Phone3, | | |
| | | | Fax1, | | |
| | | | Fax2, | | |
| | | | Email, | | |
| | | | Contact, | | |
| | | | Gzone, | | |
| | | | DefaultZone, | | |
| | | | enabled | | |
| Stored | dbo.Usp_{—} | dbo.Usp_Supplier_{—} | SupplierId, | | This proc will |
| Procedure | Supplier_{—} | i_OverRideStates | OverRideState | | insert override |
| | i_OverRide | | | | states in |
| | States | | | | ADMINISTRATION |
| | | | | | SYSTEM_override |
| | | | | | states table |
| Stored | dbo.Usp_{—} | dbo.Usp_Supplier_{—} | ADMINISTRATION | ADMIN- | This proc will |
| Procedure | Supplier_{—} | iu_ShipPoint | SYSTEM_{—} | ISTRATION | insert Ship point |
| | iu_ShipPoint. | | ShipPoint_ID, | SYSTEM_{—} | details in to |
| | PRC | | Code, | Ship | ADMINISTRATION |
| | | | Name, | Point_ID | SYSTEM_Ship |
| | | | Address1, | | Point table |
| | | | Address2, | | |
| | | | City, | | |
| | | | State, | | |
| | | | Zip, | | |
| | | | Phone1, | | |
| | | | Phone2, | | |
| | | | Phone3, | | |
| | | | Fax1, | | |
| | | | Fax2, | | |
| | | | Email, | | |
| | | | Contact, | | |
| | | | Comments, | | |
| | | | IsSupplierPhysical | | |
| | | | Location | | |
| Stored | dbo.Usp_{—} | dbo.Usp_Supplier_{—} | ShippingID, | Shipping | This proc will |
| Procedure | Supplier_{—} | iu_Shipping | ShipPointCode, | ID | insert or update |
| | iu_Shipping | | Priority,Enabled | | shipping |
| | | | CutOffTime, | | information |
| | | | AccountNumber1 | | about supplier |
| | | | AccountNumber2, | | and its related |
| | | | AccountNumber3, | | ship points. |
| | | | AccountNumber4, | | |
| | | | RoutingZip, | | |
| | | | IsFullService, | | |
| | | | Supplier | | |
| | | | Code, | | |
| | | | CarrierShip | | |
| | | | TypeID | | |
| Stored | dbo.Usp_{—} | dbo.Usp_Supplier_{—} | ShippingPeriod | | This proc will |
| Procedure | Supplier_{—} | iu_Enabled | ID, | | Insert/Update |
| | iu_Enabled | Period | ShippingID, | | Enabled Period |
| | Period | | EnabledStart | | in to |
| | | | Date, | | ADMINISTRATION |
| | | | EnabledEndDate | | SYSTEM_Shipping_{—} |
| | | | | | Period |

Consider the following as representative of a way of handling the main routing logic:
Receive an order
Retrieve order information

If it is an AM delivery:

Try Air Shipping one day ship/supplier logic
If successful or pre-validated
Choose air overnight service level, supplier, and ship location from logic returned result
Process the appropriate air overnight for AM delivery (FedEx Express or UPS Air) shipment
Return
End If

Logic Error—no more shipping types to try
End if.

If it is a PM delivery:
If Monday delivery
   Try Ground Shipping one-day ship/supplier logic

If successful
Choose ground service level, supplier and ship location from logic returned result
Process the shipment as UPS Ground
Return

End If
Try Air Shipping one day ship/supplier logic
If successful or pre-validated
Choose air overnight service level, supplier and ship location from logic returned result
Process the appropriate air overnight (FedEx Express or UPS Air) shipment
Return
   End If
   Logic Error—no more shipping types to try

End If

If not Monday delivery
If 2^{nd} day product
If Flexible Delivery And Guaranteed Next Day
Try Ground Shipping one-day ship/supplier logic
   If successful
Choose ground service level, supplier and ship location from logic returned result
Process the appropriate ground (FedEx Ground/FHD or UPS Ground) shipment
Return
   End If
Try Ground Shipping two-day ship/supplier logic
If successful
Choose ground service level, supplier and ship location from logic returned result
Process the appropriate ground (FedEx Ground/FHD or UPS Ground) shipment
Return
   End If
Try Air Shipping one day ship/supplier logic
   If successful or pre-validated
Choose air overnight service level, supplier and ship location from logic returned result
Process the appropriate air overnight (FedEx Express or UPS Air) shipment
Return.
   End If
      Logic Error—no more shipping types to try
End If (Flexible Delivery And Guaranteed Next Day)
If not Flexible Delivery Or (Flexible Delivery And NOT Guaranteed Next Day)
   Switched one-day and two-day logic below as one-day is cheaper (per Neil Brooks—Nov. 25, 2003 JB)
      Try Ground Shipping one-day ship/supplier logic
   If successful
Choose ground service level, supplier and ship location from logic returned result
Process the appropriate ground (FedEx Ground/FHD or UPS Ground) shipment
Return
   End If
Try Ground Shipping two-day ship/supplier logic
If successful
Choose ground service level, supplier and ship location from logic returned result
Process the appropriate ground (FedEx Ground/FHD or UPS Ground) shipment
Return
   End If
Try Air Shipping 2 Day ship/supplier logic
   If successful or pre-validated
Choose air 2 day service level, supplier and ship location from logic returned result
Process the appropriate air (FedEx Express 2 Day or UPS 2^{nd} Day Air) shipment
Return.
   End If
      Try Air Shipping one day ship/supplier logic
      If successful or pre-validated
Choose air overnight service level, supplier and ship location from logic returned result
Process the appropriate air overnight (FedEx Express or UPS Air) shipment
Return.
   End If
      Logic Error—no more shipping types to try
End If (not Flexible Delivery Or (Flexible Delivery And NOT Guaranteed Next Day))
   End If (2^{nd} day product)
      If one day product
      Try Ground Shipping one-day ship/supplier logic
   If successful
Choose ground service level, supplier and ship location from logic returned result
Process the appropriate ground (FedEx Ground/FHD or UPS Ground) shipment
Return
   End If
      Try Air Shipping one day ship/supplier logic
      If successful or pre-validated
Choose air overnight service level, supplier and ship location from logic returned result
Process the appropriate air overnight (FedEx Express or UPS Air) shipment
Return.
   End If
      Logic Error—no more shipping types to try
   End If (one day product)

End If (not Monday delivery)
End If (PM delivery)

With regard to components identified:
Air Shipping one day ship/supplier logic:
If Monday delivery
Set ship date the Saturday before
Else
Set ship date one day before the delivery date
End If
If ship date is before today

Return not successful
End If
If a holiday occurs within the ship date and delivery date range

Return not successful
End If
Return Residential/Commercial determination logic:
Get all suppliers with all relevant data (child productID, child product priority, supplier id, override state, inventory id, inventory quantity, ship locations, and carriers) that satisfy
UPS Air OR FedEx Express is enabled
Carrier Air cutoff date/time (ship date/time) is greater than current date/time (all ship locations—supplier and drop ship hubs)
Inventory greater than 0 for the product on the specified ship date

Supplier Ship Location: Apply state override if recipient state is within the states defined for the supplier state override

Drop Ship Hub Ship Location: Recipient zip code is one day time in transit from ship location
Order by drop ship hub priority ASC, state override DESC, child product priority ASC, quantity DESC
If returned dataset is empty
Return not successful
End If
For each supplier in the dataset
Based on the result obtained earlier thru Residential/Commercial determination logic
If AM delivery or Saturday
   If supplier selected FedEx Express
Choose FedEx Express Priority if Service Level validation succeeds
   Else If supplier selected UPS Air
      Choose UPS Next Day Air if Service Level validation succeeds
End If
Else If PM delivery
   If supplier selected FedEx Express
Choose FedEx Express Standard if Service Level validation succeeds
If FedEx Express Standard validation fails
Choose FedEx Express Priority if Service Level validation succeeds
   End If
   Else If supplier selected UPS Air
Choose UPS Next Day Air Saver if Service Level validation succeeds
   End If
End If
If service level is chosen
Inventory adjustment
Return successful with the selected child product id, supplier id, ship date, ship location zip code, air service level, residential/commercial shipment.

End If
End For

Air Shipping 2 Day ship/supplier logic:
Set ship date to two days before delivery date
If ship date is Saturday Or Sunday

Return not successful
End If
If ship date is before today

Return not successful
End If
If a holiday occurs within the ship date and delivery date range

Return not successful
End If
Return Residential/Commercial determination logic
Get all suppliers with all relevant data (child productID, child product priority, supplier id, override state, inventory quantity, ship location, and carrier) that satisfy
UPS Air OR FedEx Express is enabled
Carrier Air cutoff date/time (ship date/time) is greater than current date/time time (all ship locations—supplier and drop ship hubs)
Inventory greater than 0 for the product on the specified ship date

Supplier Ship Location: Apply state override if recipient state is within the states defined for the supplier state override
Drop Ship Hub Ship Location: Recipient zip code is two days time in transit from ship location
Order by drop ship hub priority ASC, state override DESC, child product priority ASC, quantity DESC
If returned dataset is empty
Return not successful
End If
For each supplier in the dataset
Based on the result obtained earlier thru Residential/Commercial determination logic
If supplier selected FedEx Express
   Choose FedEx Express 2^{nd} Day if Service Level validation succeeds
If FedEx Express 2 Day validation fails
If supplier selected UPS Air AND delivery date is NOT Saturday
Choose UPS 2^{nd} Day Air if Service Level validation succeeds
   End If
End If
Else If supplier selected UPS Air AND delivery date is NOT Saturday
   Choose UPS 2^{nd} Day Air if Service Level validation succeeds
End If
If service level is chosen
Inventory adjustment
Return successful with selected child product id, supplier id, ship date, ship location zip code, air service level, residential/commercial shipment.
End If
End For
Ground two-day ship/supplier logic:
If delivery date is Monday

Return not successful
End If
Set ship date to two days before delivery date
If ship date is Sunday

Return not successful
End If
If ship date is before today

Return not successful
End If
If a holiday occurs within the ship date and delivery date range

Return not successful
End If
Return Residential/Commercial determination logic
Get all suppliers with all relevant data (child productID, child product priority, supplier id, inventory quantity, ship location, and carrier) that satisfy
FedEx Ground/FHD OR UPS Ground is enabled
Carrier Ground cutoff date/time (ship date/time) is greater than current date/time (all ship locations—supplier and drop ship hubs)
Inventory is greater than 0 for the product on the specified ship date
Recipient zip code is two days time in transit from ship location
Order by drop ship hub priority ASC, child product priority ASC, quantity DESC
If returned dataset is empty

Return not successful
End If
For each supplier in the dataset
Based on the result obtained earlier thru Residential/Commercial determination logic

If supplier selected UPS Ground and delivery date is NOT Saturday
Choose UPS Ground if Service Level validation succeeds

Else If supplier selected FedEx Ground/FHD
If Delivery Date is Saturday and Residential Shipment

Choose FedEx FHD if Service Level validation succeeds
Else

Choose FedEx Ground if Service Level validation succeeds
End If
End If
If service level is chosen
Inventory adjustment
Return successful with the selected child productID, supplierID, shipDate, ship location zip code, ground service level, residential/commercial shipment.

End If
End For
Return not successful
Ground one-day ship/supplier logic:
If ship date is before today

Return not successful
End If
If a holiday occurs within the ship date and delivery date range

Return not successful
End If
Return Residential/Commercial determination logic
Get all suppliers with all relevant data (child productID, child product priority, supplier id, inventory quantity, ship location, and carrier) that satisfy
FedEx Ground/FHD OR UPS Ground is enabled
Carrier Ground cutoff date/time (ship date/time) is greater than current date/time (all ship locations—supplier and drop ship hubs)
UPS Ground and Delivery Day is Monday: Inventory is greater than 0 for the product on Saturday
All Other Cases: Inventory is greater than 0 for the product one day before the delivery date
Recipient zip code is one day time in transit from ship location
Order by drop ship hub priority ASC, child product priority ASC, quantity DESC
If return dataset is empty

Return not successful
End If
For each supplier in the dataset
Based on the result obtained earlier thru Residential/Commercial determination logic

If supplier selected UPS Ground and delivery date is NOT Saturday
If delivery day is Monday
Set ship date to three days before the delivery date
Else
Set ship date to one day before the delivery date
End If
Choose UPS Ground if Service Level validation succeeds

Else If supplier selected FedEx Ground/FHD and delivery date is NOT Monday
Set ship date to one day before the delivery date
If Delivery Date is Saturday and Residential Shipment
Choose FedEx FHD if Service Level validation succeeds
Else
Choose FedEx Ground if Service Level validation succeeds
End If

End If
If service level is chosen
Inventory adjustment
Return successful with the selected child productID, supplierID, shipDate, ship location zip code, ground service level, residential/commercial shipment.

End If
End For
Return not successful

As to service level validation:
FedEx Express—Priority, Standard, 2^{nd} Day:
If already validated from Order Processing

Return true
Else If not validated and Heavy Strategy is enabled

Return validation from FedEx server transaction
Else

Return true
End If
Others: (UPS—Next Day Air, Next Day Air Saver, 2^{nd} Day Air, Ground; FedEx—Ground/FHD)
If Heavy Strategy is enabled
If 1 day ship
Return validation for 1 day ship to a residential or commercial zip code

Else If 2 day ship
Return validation for 2 day ship to a residential or commercial zip code

End If
Else (Light Strategy)

Return true
End If

Consider now representative residential/commercial determination logic:
If Recipient Location type is one of (Business, Funeral Home, Hospital)

Return Commercial shipment
Else if Recipient Location type is one of (Residential, Apartment, Dormitory)

Return Residential shipment
Else
If companyName exists

Return Commercial shipment
Else

Return Residential shipment
End If
End If
Consider now representative deployments.

All .Net Servers

| | |
|---|---|
| All .Net Servers | |
| ADMINISTRATION | From: |
| SYSTEMApplication.config | $\Src_UPS3_VDay\<build#>\Administration |
| | System_Config\Administration Systemapplication.config |
| | To: |
| | F:\Administration System \Config |
| Machine.config | From: |
| | $\Src_UPS3_VDay\<build#>\Machine_Config\machine.config |
| | To: |
| | C:\WINDOWS\Microsoft.NET\Framework\v1.1.4322\CONFIG |
| Security Settings | |
| Web Applications | |
| BOE | From: |
| | $\Src_UPS3_VDay\<build#>\Administration System |
| | \Application\Web\BOE\machine.config |
| | To: |
| | F:\ADMINISTRATION SYSTEMBoe\Boe |
| WEBServices | |
| FulfillmentService | From: |
| | $\Src_UPS3_VDay\<build#>\Administration System |
| | \Application\WebServices\Fulfillment |
| | To: |
| | F:\ADMINISTRATION SYSTEMServices\FulfillmentService |
| OrderService | From: |
| | $\Src_UPS3_VDay\<build#>\Administration System |
| | \Application\WebServices\OrderManagement |
| | To: |
| | F:\ADMINISTRATION SYSTEMServices\OrderService |
| TransactionService | From: |
| | $\Src_UPS3_VDay\<build#>\Administration System |
| | \Application\WebServices\TransactionRouter |
| | To: |
| | F:\ADMINISTRATION SYSTEMServices\TransactionService |
| ProductService | From: |
| | $\Src_UPS3_VDay\<build#>\Administration System |
| | \Application\WebServices\productservice |
| | To: |
| | F:\ADMINISTRATION SYSTEMServices\ProductService\ |
| MonitorService | From: |
| | $\Src_UPS3_VDay\<build#>\Administration System |
| | \Application\WebServices\Monitoring |
| | To: |
| | F:\ADMINISTRATION SYSTEMServices\MonitorService |
| ScanDataService | From: |
| | $\Src_UPS3_VDay |
| | \<build#>\3rdParty\ScanData\Application\WebServices\ |
| | ScanData\bin |
| | To: |
| | F:\ADMINISTRATION |
| | SYSTEMServices\ThirdPartyServices\ScanDataService\bin |
| Backoffice | |
| Reroute | From: |
| | $\Src_UPS3_VDay\<build#>\Administration System |
| | \Application\Web\Fulfillment\Reroute\ |
| | To: |
| | F:\Administration Systembackoffice\reroute |
| SupplierManagement | From: |
| | $\Src_UPS3_VDay\<build#>\Administration System |
| | \Application\Web\SupplierManagement |
| | To: |
| | F:\Administration Systemadmin\backoffice\SupplierManagement |
| | NOTE: For first-time deployment |
| | Create folder F:\Administration |
| | Systemadmin\backoffice\SupplierManagement on order box. |
| | Create virtual directory for reroute web application. |
| JMS files (webservices) | |
| ScanData Application | |
| .NET Windows Services | |
| Services Servers: | |
| Admin Servers | |
| Admin | From: |
| bonavigator.cfm | $\Dev_ADMINISTRATION |
| | SYSTEM2000\Src_UPS3_VDay\WebPages\Admin |
| | To: |
| | F:\BMAO\admin |
| Root | From: |
| cfm_config_server_constants.inc | $\Dev_ADMINISTRATION |
| | SYSTEM2000\Src_UPS3_VDay\WebPages\Root |
| | To: |
| | F:\BMAO |

Automate Schedulers

With respect to the code, all scripts run using <xxxxxx.cmd> <servername> <databasename> All Databases should be backed up before running the following.
OTLP 28
Upgrade script location:
Dev.Net$/Studio2003_Compatible/Src_UPS3_VDay/Administration System/Databases/OLTP/OLTP.cmd
Fulfillment Processing
Upgrade script location:
Dev. Net$/Studio2003_Compatible/Src_UPS3_VDay/Administration System/Databases/FulfillmentProcessing\Fulfillment.cmd
Fulfillmentqueue
Upgrade script location:
Dev. Net$/Studio2003_Compatible/Src_UPS3_VDay/Administration System/Databases/FulfillmentQueue/FulfillmentQueue.cmd
Email:
Upgrade script location:
Dev. Net$/Studio2003_Compatible/Src_UPS3_VDay/Administration System/Databases/Email/Email.cmd
Archive:
Upgrade script location:
Dev. Net$/Studio2003_Compatible/Src_UPS3_VDay/Administration System/Databases/Archive/Archive.cmd
ScanData:
Upgrade script location:
Dev. Net$/Studio2003_Compatible/Src_UPS3_VDay/Administration System/Databases/ScanData/DCS_PC/Create Scripts/Stored Procedures/up_PrintUPSLabel.sql
Run against the ScanData DCS_PC database.

To install and Run DTS Packages, with reference to the code in the appendix: Go to Enterprise Manager. Open the destination server (ADMINISTRATION SYSTEMSQL7), right click on Data Transformation Services folder, and “Open Package”. Then locate the package called “UPS3_Upgrade.dts” under the DTS folder of “Database\OLTP\Create Script”. Double click to open the package and then change the SQL Server connection object to the destination server. Note there are two connections: OLTP and FulfillmentQueue. Need to change both (don't clear transformations). Save this package as a SQL Server Package under the destination server, then close the DTS designer. Right click on the new DTS package and “Schedule Package”, and click OK. Then go to Enterprise Manager>Management>SQL Agent>Jobs, and find the job just created, then start job. Clean up. Delete the job, then delete the DTS package that was just created.

Although only a few exemplary embodiments have been described in detail above, those skilled in the art will readily appreciate that many modifications are possible in the exemplary embodiments without materially departing from the novel teachings and advantages herein. Accordingly, all such modifications are intended to be included within the scope defined herein. Means-plus-function is intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

LENGTHY TABLE
The patent application contains a lengthy table section. A copy of the table is available in electronic form from the USPTO web site (http://seqdata.uspto.gov/?pageRequest=docDetail&DocID=US20070192124A1). An electronic copy of the table will also be available from the USPTO upon request and payment of the fee set forth in 37 CFR 1.19(b)(3).

We claim:

1. A method of making a computer system, the method including:
providing a computing system interposed between an e-commerce order receiving system and one of a plurality of shipment provider computer systems, the computer system adapted to send, across a wide area network, a real-time stream of delivery date-specific orders.

2. The method of claim 1, wherein the computer system interposed between a multi-carrier management system and the wide area network.
